(19) United States
(12) Patent Application Publication
(10) Pub. No.: US 2017/0032421 A1
(43) Pub. Date: Feb. 2, 2017

(54) Merchant-Traveler Messaging Systems And Methods

(71) Applicant: Chalumeau Consulting Services, LLC, Warrenton, VA (US)

(72) Inventor: William T. Semple, Warrenton, VA (US)

(21) Appl. No.: 15/292,994

(22) Filed: Oct. 13, 2016

Related U.S. Application Data
(63) Continuation of application No. PCT/US16/31213, filed on May 6, 2016.
(60) Provisional application No. 62/158,479, filed on May 7, 2015.

(51) Int. Cl. G06Q 30/02; G06Q 30/08

(52) U.S. Cl. CPC G06Q 30/0261; G06Q 30/08

(57) ABSTRACT

A system, method and software medium, send merchant alerts to a traveler. A traveler alert server receives at least one bid defining one or more keywords and a corresponding alert from each of a plurality of merchants. The traveler alert server receives location data defining a current location of the traveler from a location aware device (LAD). The corresponding alerts are ordered by performing a generalized second-price (GSP) auction based upon the location data, a merchant location of each of the plurality of merchants, and the at least one bid of each of the plurality of merchants. The ordered corresponding alerts are sent to the LAD for display to the traveler.

### RELATED APPLICATIONS

This application is a Continuation of International Application Number: PCT/US16/31213, filed May 6, 2016, which claims priority to Patent Application Ser. No. 62/158,479, titled, “Merchant Traveler Messaging Systems and Methods,” filed May 7, 2015, each of which is incorporated herein in its entirety.

### FIELD OF THE INVENTION

The present disclosure is related generally to advertising and/or on-line auction markets and more particularly to techniques for generating dynamic auction advertising or buyer-seller auctions responsive to the locations of travelers along a travel route relative to the locations of the merchants/advertisers based primarily on the time of travel interval between such locations. The disclosed systems and methods influence the decisions of travelers to purchase a product or service from merchants along or near the said travel routes as well dynamically resolving bids and message content in response to said time of travel interval and other variables as further disclosed.

### BACKGROUND

Whether a traveler is a motorist, a passenger on public conveyance, a bicyclist or a pedestrian, merchants have not been able to take direct advantage of a traveler while in motion to disseminate advertising particular to a specific traveler based on the location of the traveler relative to the merchant and dynamically responsive to the merchant's business needs, despite the advent of the smartphone and related location-based technologies.

Tens of thousands of merchants located along our nation's roadways, for example, watch millions of travelers pass by, wondering how such travelers can be more effectively influenced to become customer as they approach the merchant's location.

Merchants have historically relied on passive and static advertising to attract travelers, e.g., road side billboards, pamphlets arranged in bins at rest stops, storefront advertising, window displays, travel related magazines, and the ubiquitous Sky Mall magazine. It is only coincidence that a road sign matches a traveler's desires at the time the traveler passes the sign. More importantly, merchants are unable to modify their message as the traveler approaches the merchant location other than to erect more road signs. Some travelers may remember the “South of the Border” signs along U.S. 95 which became more intense and creative as the traveler approached the exit to the tourist attraction with the sign immediately past the relevant exit declaring “You missed! TURN AROUND!”

To strengthen the link between the merchant and traveler's respective geographic locations, on-line advertising such as described in U.S. Pat. No. 8,296,335 “Method for Advertising Information” improved upon “hard copy” by linking advertising to “local search” results. The essential flaw to this technology and the derivatives that followed is that merchants remain dependent on the traveler finding the merchant and reliant on predetermined content that bears no relevance to the ever-changing geographic relationship between the merchant and the traveler that affects both merchant and traveler profiles irrespective of whether the merchant is a destination or not—a drawback that occurs at all levels of travel, from foot to flight.

With respect to travelers traveling along a route, recent prior art narrowed the relevant geographic vicinity to a known travel route: U.S. Pat. No. 8,659,176 to Google describes system and methods for providing information about vendors to a user based on geographic proximity to a route identified by the user; U.S. Publication 2012/0143689 to TeleNav, Inc. provides an advertising delivery system that tailors notifications to users by matching a “delivery profile” to a selected “category of interest” within a “travel context” but only after receiving a user entry for a destination, defined as “the target geographic location where the user will end his or her travel.” U.S. Pat. No. 8,566,026 to Trip Routing Technologies LLC describes an article of manufacture for notifying users of transitory road-trip events based on receiving routing parameters from users.

### SUMMARY

A more effective approach for merchant advertising than as disclosed by the prior art would be a system that tailors messages based on the location of a traveler along a route relative to the merchant using a proximity measure most relevant to the merchant, dynamically informs the content of the message as the traveler moves along the route, further adjusts the message according to the traveler's profile, if known, the travel route profile, if known, and to the merchant's business needs; and to achieve scale, delivers the content through one or more competitive on-line advertising auctions, such as found in Google's AdWords or in Google Now, where the timing, content and cost of the advertising can be controlled by the merchant through a keyword bidding process. As used herein, the terms traveler and user may be used synonymously when referring to the system and devices hereof.

The on-line keyword auction approach allows the merchant to be extremely flexible. For example, while known travel routes are a bonus and a final destination may be useful to the traveler as described above, it may be of more important concern to the merchant to target as many travelers as possible who may pass near or arrive at the merchant's location. A relevant route can be established based on the road and direction a motorist may be traveling, or in the case of a pedestrian, on the street and direction the pedestrian may be walking. On the other hand, a merchant is more likely to pay more for keywords if the probability of a traveler passing the merchant's entrance approaches 100%. Thus a heuristic algorithm or other technique known to persons of ordinary skill may be incorporated to assist the merchant in judging such costs.

Keywords also address other information about the traveler and travel conditions can may have a direct bearing on a particular bid, such as traveler preferences and traveler history as may be known, the weather, time of day.

Rather than a radius or lineal distance, the proximity measure most relevant to a merchant is preferably defined by remaining time of travel (“RTT”) or its mathematical alternatives, e.g., estimated time of arrival (“ETA”). RTT is especially relevant to time-sensitive services, such as restaurants and lodging, and dispenses the need for the merchant to know anything else about the location, travel conditions or travel mode, and takes advantage of many of the newer features built into such applications as Google Maps.

While the preferred embodiment is directed primarily to motorists along a route, the principles apply to all modes of transportation. This allows local vendors along a busy shopping street to track the location of the pedestrian to transmit offers based on the location of both the vendor and the pedestrian along a known, unknown, predetermined or predicted path. The data used to predict a pedestrian's likely destination can be based on myriad factors, including the presence of nearby metro stops, the direction of the pedestrian and the previous path of the pedestrian. For example, if the system is informed that the pedestrian has exited a metro stop at K & Connecticut in Washington, D.C., there are only so many streets the pedestrian is likely to travel in any direction.

The heuristic algorithm described above can be updated instantaneously as the pedestrian moves in any particular direction. If the pedestrian crosses the street, then the algorithm replaces the expected direction of travel with a new prediction based on the network of streets available to the pedestrian at that precise moment. This prediction likewise incorporates data about the geographic vicinity. A pedestrian at K & Connecticut may be interested in shopping, going to work, walking down to the White House, or having lunch. Data informing the prediction can include the time of year, the time of day, the weather, the presence of landmarks, the existence of nearby entertainment, including movies and their show times, social media if available, the traveler's prior travel history, and the traveler profile, the latter dependent on the traveler's privacy settings.

To assist the merchant in managing an advertising program, the disclosed embodiment hereof contemplates a back-end computer system that can be programmed to analyze bids based on a merchant's business model, e.g., a motel's break-even history or a business' return on investment.

To determine the visibility of merchant messages to travelers and to monetize the embodiments hereof, the system may initiate one or more types of auction, preferably the Generalized Second Price Auction or the Reverse Auction. However, other auction types may be employed as needed either alone, in combination, or modified, e.g., the sealed-bid market auction, the Dutch-tradition (Dutch Flower Market), the Public Reverse English Auction, or the Name Your Own Price Auction. While the prior art discloses one or more of such auctions in Internet commerce, including the use of keyword and geographic contexts as disclosed by U.S. Pat. No. 8,655,761 to Google, none associates auctions to either a time interval or a distance interval between travelers and merchants or other routecentric keywords along known or hypothetical routes

An auction system delivers alerts from merchant along a travel path based on where the traveler is at any given moment and/or in conjunction with a system that helps the merchant both cost out the bid and develop an appropriate message responsive to the merchant's business at the time the alert is transmitted.

In an embodiment, a method sends merchant alerts to a traveler. A traveler alert server receives at least one bid defining one or more keywords and a corresponding alert from each of a plurality of merchants. The traveler alert server receives location data defining a current location of the traveler from a location aware device (LAD). The corresponding alerts are ordered by performing a generalized second-price (GSP) auction based upon the location data, a merchant location of each of the plurality of merchants, and the at least one bid of each of the plurality of merchants. The ordered corresponding alerts are sent to the LAD for display to the traveler.

In an embodiment, a traveler alert server sends merchant alerts to a traveler. The server includes at least one processor; a memory; a merchant locations system login (MLSL) for receiving, from each of a plurality of merchants, at least one keyword bid corresponding to a merchant location; an auction server for performing a generalized second-price (GSP) auction based upon location data defining a current location of the traveler received from a location aware device (LAD), the merchant location of each of the plurality of merchants, and the at least one keyword bid, to order a plurality of alerts corresponding to the at least one keyword bid; an alert generator for sending the ordered alerts to the LAD for display to the traveler; and a transaction module for receiving an input indicating selection of one of the ordered alerts by the traveler.

In an embodiment, a non-transitory computer readable medium with computer executable instructions stored thereon are executed by a traveler alert processor to perform the method of sending merchant alerts to a traveler. The computer executable instructions include instructions for receiving, from each of the plurality of merchants, at least one bid based upon business rules defining keywords and a corresponding alert; instructions for receiving, within a traveler alert server from a location aware device (LAD), location data defining a current location of the traveler; instructions for performing a generalized second-price (GSP) auction based upon the location data, a merchant location corresponding to the at least one bid of each of the plurality of merchants, and a value of the at least one bid of each of the plurality of merchants to order the corresponding alerts based upon results of the auction; and instructions for performing a reverse auction by sending the ordered corresponding alerts to the LAD for display to the traveler and starting a timer for the reverse auction defining a period when the traveler may respond to the ordered corresponding alerts.

### BRIEF DESCRIPTION OF THE FIGURES

FIG. 1 is a high-level diagram illustrating one example traveler alert system, in an embodiment.

FIG. 2 shows one example touchscreen display of the location aware device (LAD) of FIG. 1 implemented as a smartphone with a touchscreen display for receiving traveler inputs for selectable traveler preferences, in an embodiment.

FIG. 3 shows one example touchscreen display of the LAD of FIG. 1 implemented as a smartphone with a touchscreen display for receiving traveler inputs, in an embodiment.

FIG. 4 shows one example touchscreen display of the LAD of FIG. 1 implemented as a smartphone with a touchscreen display for displaying reverse auction offers, in an embodiment.

FIG. 5 is a flowchart illustrating one example method for a combined generalized second price auction and a reverse auction, in an embodiment.

FIG. 6 shows example operation of the auction server of FIG. 1 implementing a generalized second price auction (GSP) where a merchant bids based on the remaining time of travel (RTT) of the LAD to merchant locations stored in the MLSL, in an embodiment.

FIG. 7 is a flow chart illustrating one example method for transmitting merchants' alert offers or advertisements to the LAD of FIG. 1 from the traveler alert server based on the RTT or estimated time of arrival (ETA) of the LAD along a known or hypothetical route that is at or near the location of a merchant, in an embodiment.

FIG. 8 is a flowchart illustrating one example method for using the RTT of the LAD of FIG. 1 as a keyword that first selects eligible merchants and is then applied as one of one or more keywords in a generalized second price auction to order merchant and advertising alerts, in an embodiment.

FIG. 9 shows example implementations of the LAD of FIG. 1.

FIG. 10 is a table illustrating example content generated by the merchant advertiser business rules of FIG. 1, in an embodiment.

FIG. 11 shows example alert adjustments based upon “Time Remaining to Destination” merchant advertiser business rules, in an embodiment.

FIG. 12 is a schematic illustrating differences between RTT and distance for three example LADs of FIG. 1.

FIG. 13 is a table showing example RTT for the LAD of FIG. 1 to arrive at a merchant destination, in an embodiment.

FIG. 14 is a table illustrating example routecentric keywords defined within the merchant advertiser business rules of FIG. 1, in an embodiment.

FIG. 15 is a table illustrating example keyword categories with associated example keywords and corresponding bid values as defined within the merchant advertiser business rules of FIG. 1, in an embodiment.

FIG. 16 is a continuation of the tables of FIGS. 12 and 13, listing additional search terms/keywords, in an embodiment.

FIG. 17 is a schematic illustrating how the traveler alert system of FIG. 1 determines RTT over a multi-modal path, in an embodiment.

FIG. 18 shows a map, a table correlating RTT against business rules and a ranked bid table, that together illustrate example operation of the system of FIG. 1, in an embodiment.

FIG. 19 shows a map, a table correlating RTT against business rules, a radius keyword table, and a radius keyword followed by RTT preference keyword table, that together illustrate example operation of the system of FIG. 1 to limit eligible auction bids, in an embodiment.

FIG. 20 shows a map where the center point of the radius of FIG. 19 is the LAD of FIG. 1, in an embodiment.

FIG. 21 shows a map where the center point of the radius of FIG. 19 is a merchant location that limits the number of LAD locations eligible to receive traveler alerts, in an embodiment.

FIG. 22 shows a map where the radius of a circle sector that serves to limit hypothetical routes is the LAD of FIG. 1, in an embodiment,

FIG. 23 shows a map where a polygon limits hypothetical routes, in an embodiment.

FIG. 24 shows a map where a polygon drawn relative to a merchant location selects eligible LADs for receipt of a traveler alert, in an embodiment.

FIG. 25 shows two overlapping radii drawn relative to one or more merchant locations to limit the geo-defined eligibility of auction bids to within the intersection of the two radii.

FIG. 26 illustrates example adjustment of merchant bids by merchant/advertiser business rules server of FIG. 1 in response to three example routecentric keywords determined by and received from the traveler alert server, in an embodiment.

FIG. 27 shows a map and tables where the statistical probability of an LAD traveling one or more routes is used by the traveler alert system of FIG. 1 to adjust keyword bids, in an embodiment.

FIG. 28 shows a map and a table where the relative locations of three LADs affect the applicability of keywords based upon one or both of remaining time of travel and distance along a route.

### DETAILED DESCRIPTION OF THE EMBODIMENTS

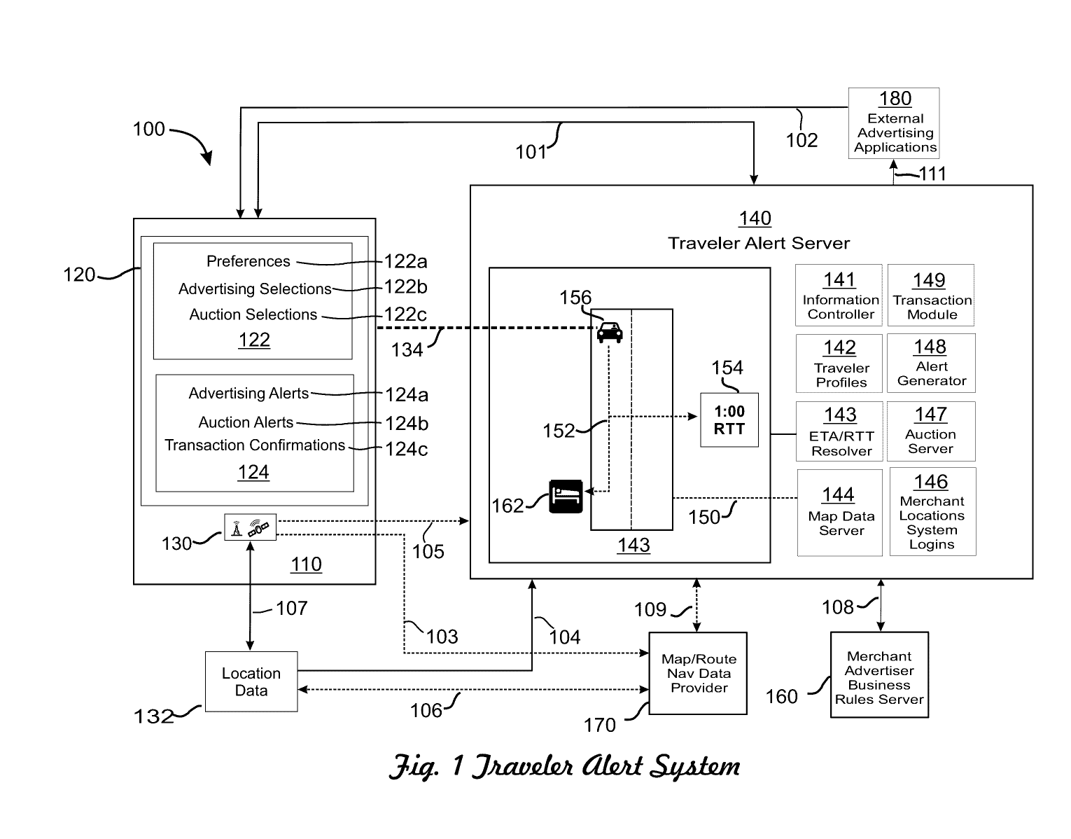

FIG. 1 is a high-level diagram illustrating one example traveler alert system 100. System 100 operates to provide traveler alerts and includes a traveler alert server 140 that communicatively couples with at least one merchant/advertiser business rules server (MBRS) 160, at least one location aware device (LAD) 110, at least one map/route/navigation data database 170, and at least one network 101, 102, 103, 104, 105, 106, 107, 108 and 109.

LAD 110 includes locator technology 130 that is capable of determining a current location of LAD 110. LAD 110 is also capable of receiving, transmitting, storing and processing electronic data, and is configured with user interface 120 with input 122 and output 124. LAD 110 may represent one or more of a smartphone, a smart watch, a cellular phone, a personal digital assistant, a tablet, a laptop, an in-dash interactive navigation device, and a portable interactive navigation device. In one embodiment, user interface 120 is implemented as a touch screen.

User interface 120 includes inputs 122 such as keyboard, touch, and/or speech recognition inputs, and outputs 124 such as displayed graphical output and/or audible outputs such as sounds and synthesized speech. Inputs 122 may include traveler preferences 122a that are transmitted to the traveler alert server 140 from LAD 110 via network 102. Inputs 122 may also include advertising selections 122b and auction offer selections 122c that are made by a traveler in response to alerts received from traveler alert server 140 and output by interface 120 as advertising alerts 124a and reverse auction alerts 124b for example.

Network 101 connects LAD 110 to traveler alert server 140. Network 101 and networks 102, 103, 104, 105, 106, 107, 108 and 109 as further described below may be implemented as any combination of local and remote network configurations, topologies and communication technology that cooperate to establish communication and transmit data and may include the Internet, internets, intranets, local area networks (LAN), wide area networks (WAN), Metropolitan Area Network (MAN), personal area network (PAN), body area networks (BAN), Car Electronics, Campus Area Network, Near Me Network (NAN), Cloud (IAN) and the like. These communication technologies may include Wi-Fi, Bluetooth, infrared, coaxial cable, optical cable, cellular, radio, microwave, Ethernet over Twisted Pair, structured cabling (e.g., CAT-5e) and POTS. Networks 101, 102, 103, 104, 105, 106, 107, 108 and 109 may be parts of a single network without departing from the scope hereof.

Locator technology 130 is embedded in LAD 110 and may be used to locate LAD 110 in conjunction with location data 132, and may be implemented as one or more of GPS, Wi-Fi, assisted global positioning (A-GPS), GSM localization, control plane locating (e.g., cellular triangulation), self-reported positioning, beacons, Bluetooth, long term evolution (LTE) employing observed time difference of arrival (OTDA), and other location-based technologies known to artisans of ordinary skill. Location techniques used by locator technology 130 may include network-based, device-based, SIM-based, IP lookup, and hybrids thereof. Alternatively, locator technology 130 may be used in conjunction with networked location data 132 to determine the location of LAD 110 indirectly, for example by using one or more of Wi-Fi positioning, including public Wi-Fi access location databases, Wireless Intrusion Prevention System (WiPS), or other similar location-based technology wherein such location is supplied to the traveler alert server 140 via network 104 and/or to third-party map/route/navigation data database 170 via network 103.

Locator technology 130 may transmit the location (e.g., latitude/longitude) of LAD 110 via network 105 to traveler alert server 140, which may utilize the received location in conjunction with map data server 144 and/or external map/route/navigation data database 170 to determine the location of the LAD 110. In one embodiment, locator technology 130 transmits the location of LAD 110 via network 103 to third-party map/route/navigation data database 170, which in turn provides traveler alert server 140 with the location of LAD 110.

Traveler alert server 140 includes an information controller 141, traveler profiles 142, an estimated time of arrival/remaining time of travel (ETA/RTT) resolver 143, map data server 144, one or more merchant locations and system logins (MLSLs) 146, an alert generator 148, an auction server 147 and a transaction server 149. Traveler alert server 140 may include a database. The information controller 141 implements control of functionality of the traveler alert server 140. Traveler profiles 142 supplements traveler preferences 122a that may be directly received from the LAD 110 with personal data about the traveler, including but not limited to on-line search, purchasing and travel history. Traveler profiles 142 is dynamically updated with information as received directly and indirectly from all sources in real time, including the cloud.

In FIG. 1, ETA/RTT resolver 143 is shown, for clarity of illustration, with a representation of an automobile location 156 that represents an automobile traveling along a travel path represented as a route 152 towards or near a merchant (e.g., a motel) represented as merchant location 162, which is located along or near route 152. LAD 110 is associated (illustratively shown as dotted line 134) with the automobile represented as automobile location 156. Merchant location 162 is stored in MLSL 146. ETA/RTT resolver 143 determines an estimated RTT 154 of LAD 110 (i.e., the automobile) to reach merchant location 162 based on one or more locations (i.e., automobile location 156) received from one or more of LAD 110, location data 132, map/route/navigation data database 170, and map data server 144, that locate the automobile along known, estimated or hypothetical route 152, based upon a road defined (indicated by dashed line 150) by map data server 144, and a location of merchant location 162, which is proximate route 152. As further described below, RTT 154 may be expressed as one or more of ETA, Time of Travel (TOT), or other equivalent data without departing from the scope hereof.

Map data server 144 may include a geographic information system, mapping application program interface (API) and mapping data, including but not limited to origins, waypoints, destinations, road vectors, geocodes, attributes, speed limits, and travel conditions. The map data server 144 may be accessed through its own mapping application program interface (API), a mapping API from a third party, such as Google Maps or OpenStreetMap, or rely on a combination of proprietary mapping API and information generated externally and/or received from third-party map/route/navigation data database 170, such as Navteq.

MLSL 146 stores merchant location 162, auction preferences, bid ranges, keyword selections, ETA selections, alert templates and other parameters such as business rules that may be updated periodically or in real time by communication with MBRS 160 via network 108. IN one embodiment, MBRS 160 is found at the merchant location and may include a website interface and/or dynamic, direct link from the merchant's business computers, e.g., reservation status, where business rules are automatically deployed in programmed bidding through the MLSL 146.

Upon receiving preferences 122a and/or receiving location data 132 and/or determining RTT 154, traveler alert server 140 invokes auction server 147 to apply business rules stored in MLSL 146 and/or forwarded from MBRS 160 via network 108 to conduct an auction, such as one of a generalized second price auction and a reverse auction.

The default auction is the generalized second price (GSP) auction, e.g. an advertising scheme based on keywords, wherein auction server 147 analyzes the price the advertiser is willing to pay based upon matching selected keywords received from preferences 122a and/or stored in traveler profiles 142 and determines the order, or rank, of advertising alerts 124a generated by alert generator 148. For example, auction server 147 selects the GSP auction when preferences 122a have not been received by merchant alert server 140 and/or when received preferences 122a do not expressly include a request for reverse auction alerts 124b. Variations of the GSP auction may include features of the Vickrey-Clark-Groves auction, English auction or other modifications as necessary, e.g., weighting of keywords and bids based on location, weather, ETA, merchant location, proximity to a route, and RTT.

Alternatively, auction server 147 may select a reverse auction. A reverse auction is a bidding scheme where merchants bid against one another either publicly or privately to offer at least one of the lowest price and other amenities to travelers to attract the business of the traveler using LAD 110. Auction server 147 selects the reverse auction typically upon request by the traveler using LAD 110 as received by and stored in traveler profiles 142, but the reverse auction is also preferably invoked when the traveler's path of travel, or route, is known.

In response to auction results, the alert generator 148 generates advertising alerts 124a and reverse auction alerts 124b and sends them to LAD 110 for display on output 124. These alerts are dynamically generated from predetermined templates or are specialized alerts depending on the requirements of auction server 147, MLSL 146 and/or MBRS 160.

Auction server 147 may enhance the generalized second price auction by treating RTT 154 (or variations thereof, such as ETA) generated by the ETA/RTT resolver 143 as a keyword and adding RTT 154 to the list of keywords for matching to other preferences 122a transmitted from LAD 110 and stored in traveler profiles 142. Thus, in real time, MLSL 146 and/or MBRS 160 may bid on a specific value or range of values corresponding to RTT 154 in the same manner as when bidding using other keywords. In response to merchant inputs received from MBRS 160, bids are stored on MLSL 146. Alternatively, bids may be generated automatically by MBRS 160 in real time based on programmed, or manually inputted criteria provided by the merchant. RTT 154 may be also expressed as a time of arrival (ETA) or time of travel (TOT).

Upon receipt of the bids from MBRSs 160 and/or MLSL 146 for a specific ETA or range of ETAs and other keywords as may be stored in travel profiles 142, auction server 147 determines an order of associated advertising alerts 124a and/or auction alerts 124b for transmission to LAD 110. In one example of operation, MBRS 160 generates a bid based upon a price a merchant/advertiser is willing to pay for an ETA between 7:00 and 7:30 PM. Based upon this bid, when ETA/RTT resolver 143 determines RTT 154 that results in an ETA for LAD 110 to arrive at merchant location 162 at or between 7:00 and 7:30 PM, auction server 147 enters the bid in the auction, and based upon auction results, orders and transmits auction alerts 124b to LAD 110. Where a merchant A bids $1, a merchant B bids $0.50, a merchant C bids $25 and a merchant D bids $ 0.10, (assuming, for simplicity, no other keywords have been bid) the order of auction alerts 124b is based on the bid value (highest to lowest) for that period (i.e., 7:00 to 7:30 PM).

Alert generator 148 generates content for advertising alerts 124a and auction alerts 124b for transmission to LAD 110 via information controller 141 and network 101 for example. Alternatively, content may be transmitted to external advertising applications 180 for distribution of the advertising content on other platforms via network 102 for example. Upon display of either advertising alert 124a or auction alert 124b on 122 user interface, the traveler using LAD 110 may select one or more of advertising selections 122b and auction selections 122c. For example, where user interface 120 is a touch screen, the traveler may select one of advertising alerts 124a and auction alerts 124b. The traveler selection is received by transaction server 149 and sent to MBRS 160, which may automatically or manually confirm the selections and send transaction confirmations 124c back to LAD 110 for output on user interface 120.

Traveler alert system 100 responds to two distinct conditions regarding LAD 110: (1) where the route and/or profile of LAD 110 is known, and (2) where the route and profile of LAD 110 is not known. System 100 dynamically applies features as these conditions change directly or indirectly. That is, system 100 may apply either the generalized second price auction or the reverse auction to organize and transmit traveler alerts 124 without departing from the scope hereof. For example, where a large number of merchants are eligible to participate in an auction transmitting alerts to a large number of LAD whose prospective routes are not known, the generalized second price auction is used to order the alerts according to merchant bids; where a small number of merchants are responsive to inputs entered into and transmitted from the LAD, the generalized second price auction is bypassed and the merchants enter into a reverse auction.

As shown in FIG. 1, system 100 includes a plurality of integrated components, each of which may be controlled by one or more entities. For example, certain portions of system 100 may be distributed among such entities so as to achieve the objectives described herein.

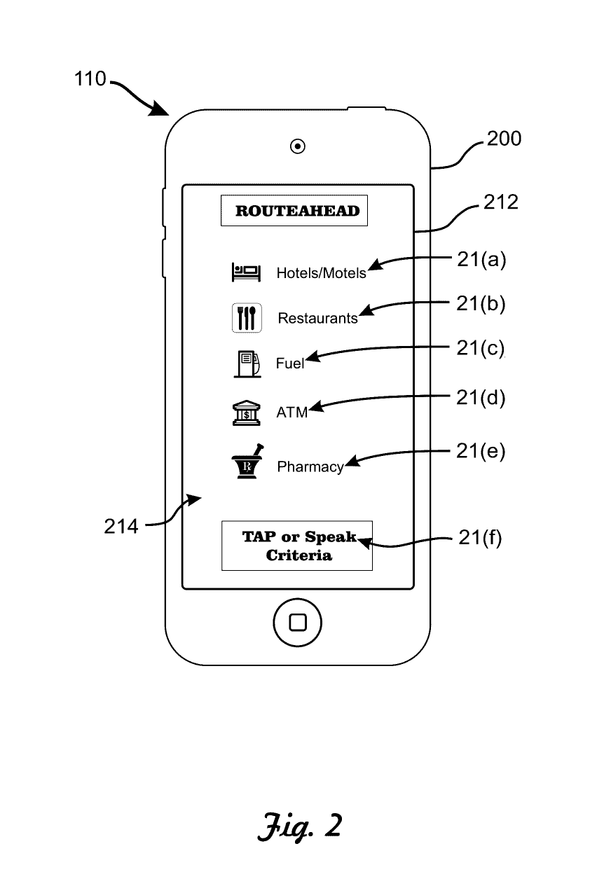

FIGS. 2, 3 and 4 show LAD 110 of FIG. 1 implemented as a smartphone 200 where user interface 120 is a touchscreen display 212. In particular, FIGS. 2, 3 and 4 show example displays 214, 215, 216, respectively, for displaying reverse auction offers and receiving traveler inputs. Smartphone 200 may include an internal microphone, one or more speakers, automatic speech recognition software, and natural language processing. In one embodiment, smartphone 200 is enhanced by an intelligent personal assistant and/or software that integrates information stored in and received by the smartphone 200.

In the example of FIG. 2, display 214 shows selectable traveler preferences 21 (see traveler preferences 122a of FIG. 1), including hotel/motels 21(a), restaurants 21(b), fuel 21(c), ATM 21(d), and pharmacy 21(e). Traveler preferences 21 define search terms or keywords and may include any word, numeral, ASCII character, symbol—spoken, selected, or written—to which any database may be responsive, including associative, distributed, key/value, stream-processed, column-oriented, parallel DBMS, massively parallel processing (MPP), relational or object-data database management, or any combination thereof. Traveler preferences 21 may be entered on one or more displays 214 configured for touchscreen display 212.

In one embodiment, LAD 110 accepts spoken or texted words or phrases and automatically determines searchable keywords. For example, in response to screen display 214, a traveler might say “I have just left Pittsburgh and am headed to Philadelphia on the Pennsylvania Turnpike. I'm tired and hungry. It is about to snow. I would like to find a cheap motel, preferably within one-hour driving time and no further than five minutes off of my current route. I don't want to spend more than $75.” Such input is transmitted from LAD 110 to server 140, independently as a text message via SMS, SMTP or other message protocols for example, or integrated into an intelligent personal assistant, from where it is sent to server 140. Server 140 converts the received information into a corresponding set of keywords that define the traveler's preferences.

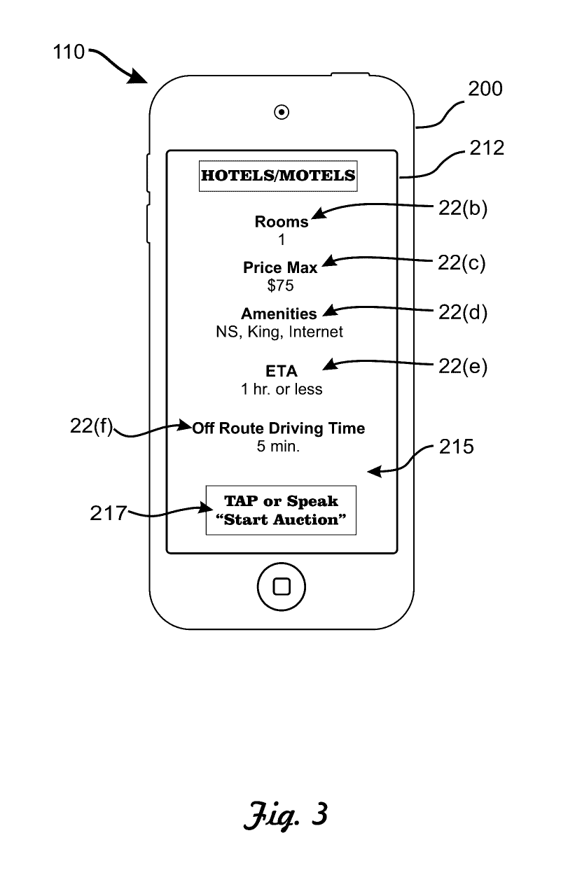

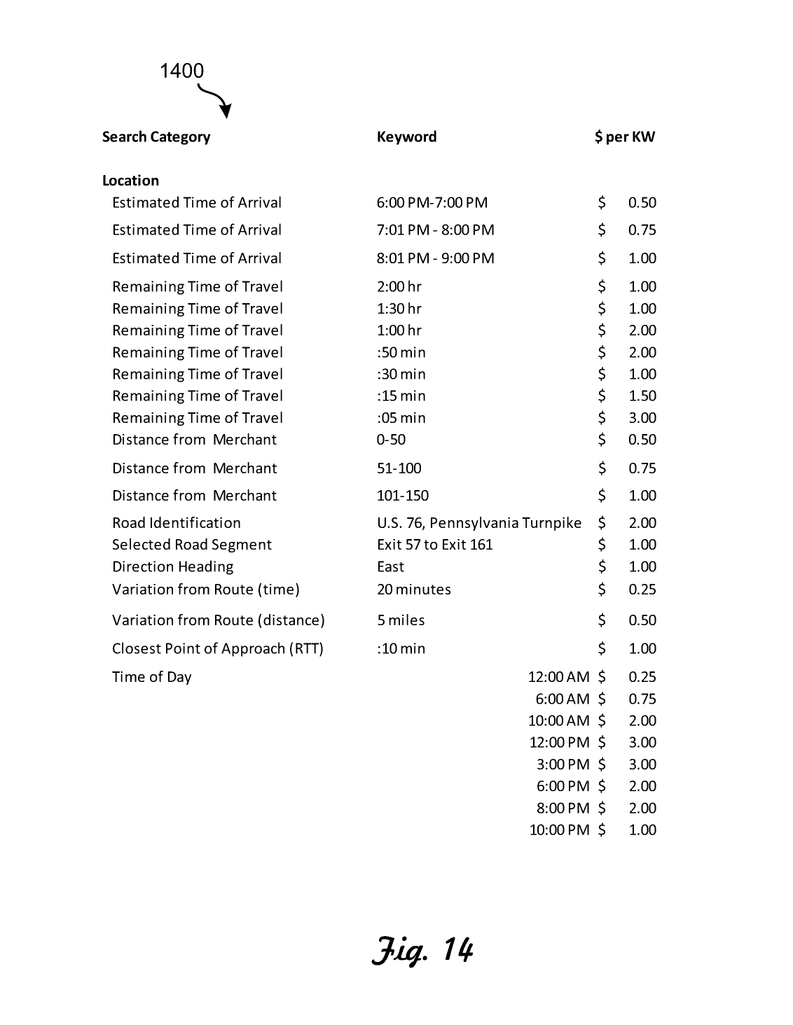

Continuing with the example of FIG. 2, tapping on traveler preference 21(a), or speaking keyword(s) “Hotels/Motels,” results in display 215 of FIG. 3. Display 215 shows a next level of preferences 22, including “Rooms 1” 22(b), “Price Max $75” 22(c), “Amenities NS (non-smoking), King-size (bed), Internet” 22(d), “ETA (estimated time of arrival), 1 hr. or less 22(e), and “Off Route Driving Time 5 min (minutes)” 22(f). Values for these preferences may be entered by the traveler as defaults or may result from traveler responses to previous input screens that replace, narrow, expand, or refine these default preferences. Example inputs that may appear on touchscreen display 212 are included in the tables of FIGS. 14, 15, and 16.

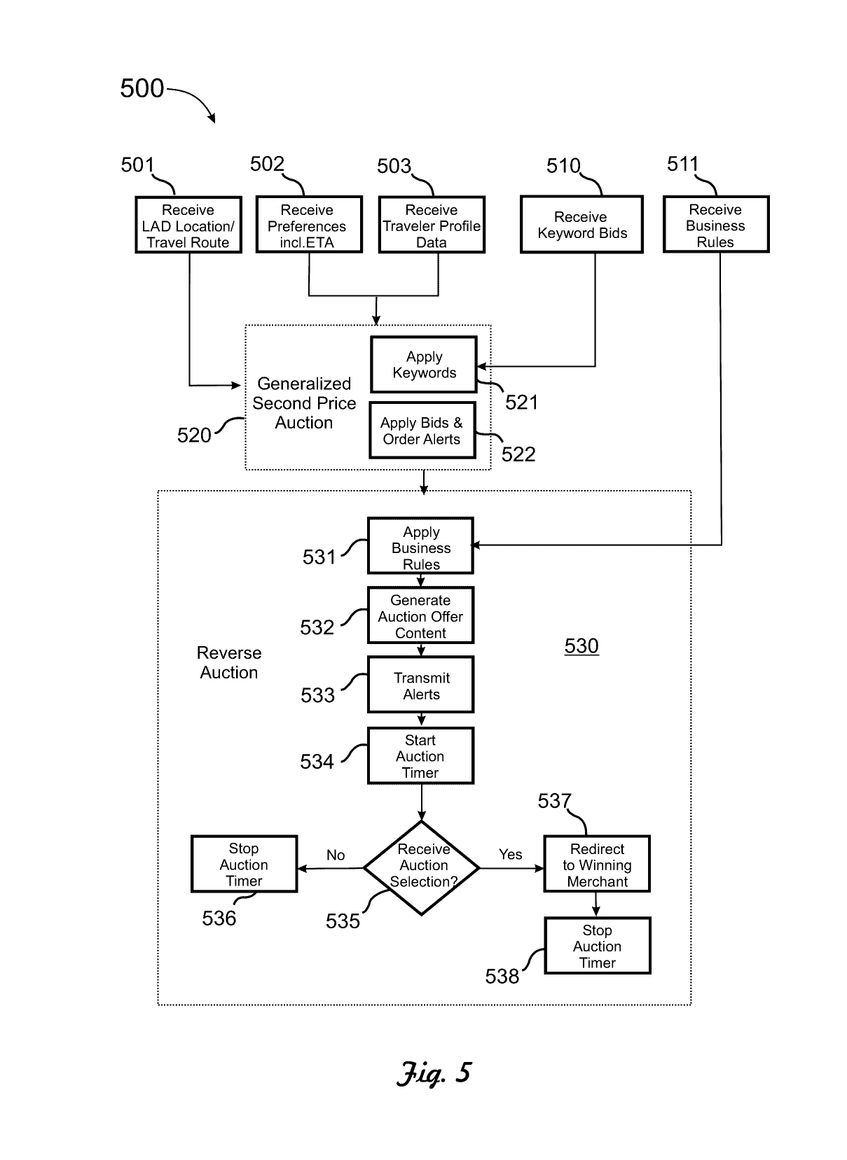

In an embodiment, tapping on, or speaking, “Start auction” 217 causes LAD 110 to transmit preferences 22(b)-22(f) to traveler alert server 140. Traveler alert server 140 (TAS), using one or more of Map Data Server 144, ETA/RTT Resolver 143, and Auction Server 147 determines the location of LAD 110, selects merchants whose locations and supplied keywords match preferences 22(b)-22(f) and conducts one or more of a generalized second price auction and/or a reverse auction that orders, generates content for, and transmits resulting auction alerts 124b to LAD 110. The specific mechanics of the auctions are described below and shown in FIG. 5 for example.

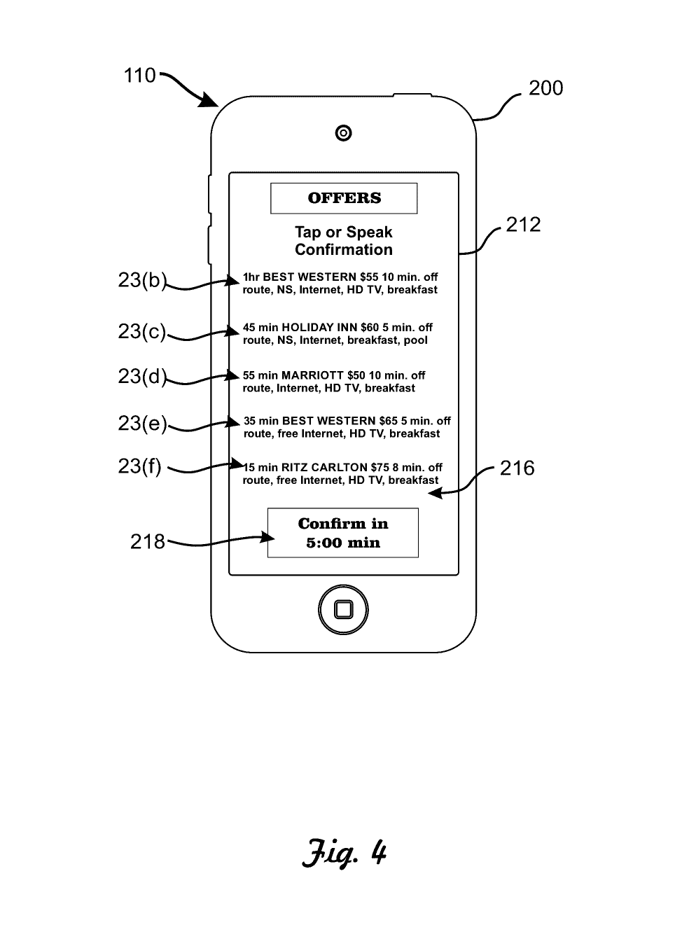

Display 216 of FIG. 4 shows a display 216 of touchscreen display 212 with five example reverse auction alert offers (RABs) 23(b)-23(f) that represent auction alerts 124b of FIG. 1. RABs 23 may also be delivered audibly using text-to-speech or similar technology such that the traveler may hear the alert offers. In one embodiment, the voice technology is enhanced to include stylistic variations, such as with sound and speech patterns of similar to an auctioneer, as selectable by either the traveler or automatically selected by auction server 147.

RABs 23 are ranked on display 216 according to the result of the generalized second price auction performed by auction server 147. Some of the content of RABs 23 may be automated, such as the RTT to the merchant location and the off route driving time, which are calculated by ETA/RTT resolver 143. In this example, the content of each RAB 23 indicates the remaining time of travel to the corresponding merchant location, the name of the corresponding merchant, the bid price from the merchant, and other amenities included in the offer. To be selected by auction server 147 for inclusion within RABs 23, the offer by the merchant should match or better preferences 22 of the traveler, and may include additional inducements. In the example of FIG. 4, RAB 23(b) offers a price of $55, one-hour travel time, or ETA, and 10 minutes driving time off the traveler's route. RAB 23(e) offers a price of $65, 35 minutes remaining travel time and 5 minutes off the traveler's route. The traveler using LAD 110 thus may choose whether convenience is more important than paying a lower price.

As shown on display 216, warning 218 may be displayed enticing the traveler to select at least one of the offers within a determined amount of time. Warning 218 may be displayed as one or more of a predetermined time, distance of travel, or location, e.g., an exit. Warning 218 may also be configured to display the remaining amount of time or distance remaining until the auction expires. A number of imaginative displays for warning 218 may include a time dial, stopwatch and corresponding sounds, such as a ticking watch.

RABs 23(b)-(f) may be limited to initial bids as shown in the example of FIG. 4. The bidders (merchants) are anonymous to one another but are not anonymous to the traveler using LAD 110. In one embodiment, bids from MBRS 160 are adjusted dynamically as travel time elapses and/or LAD 110 moves along route 152. In one embodiment, the identification of the bidders (merchants) and the bid content is transmitted to all bidders, such that each bidder may adjust his or her respective bids.

FIG. 5 is a flowchart illustrating one example method 500 for combining a generalized second-price (GSP) auction 520 and a reverse auction 530. Method 500 is implemented in traveler alert server 140 of FIG. 1, and at least partially within auction server 147.

With respect to the GSP Auction 520, location/travel route of LAD 110 is received in step 501 from map data server 144, traveler preferences FIG. 1 122a including an estimated time of arrival are received from LAD 110 in step 502 and traveler profile data are received from traveler profiles 142 in step 503, all of which are construed by auction server 147 as “search terms.”

For example, the location and route 152 of LAD 110 received in step 501 might indicate LAD 110 (and thus the associated traveler) is located sixty miles east of Breezewood, Pa. on the Pennsylvania Turnpike, traveling through Breezewood, and headed south towards Washington, D.C. All of the underlined terms in this paragraph are possible search terms, including alternative expressions of the known or hypothetical routes that the traveler is or may be taking

Traveler preferences 122a received in step 502 generally reflect the current desires of the traveler as manually inputted into the LAD 110. For example, travel preferences 122a may include products, services, prices, persons, topics of interest, mode of travel, preferred estimated time of arrival (ETA), and maximum deviation from route. For example, the traveler may be looking for two non-smoking rooms with king-sized bed with preferred time of arrival between 6:00 PM and 6:30 PM within five miles of the traveler's travel route. In another example of traveler preferences 122a, the traveler uses LAD 110 to specify routing preferences to determine the quickest or cheapest multi-transportation mode options to visit landmarks and attractions in Washington, D.C. on July 4^{th} or to determine when and where to celebrate Independence Day along, or within proximity of, the traveler's auto route that originates in Boston.

The traveler profile data (i.e., traveler profiles 142) received in step 503 is generally gleaned from indirect sources, e.g., cloud data that can be retrieved to determine a traveler's travel habits, purchasing history, and personal tastes and stored in the traveler profile FIG. 1142, Traveler profile data typically supplements the traveler preferences received in step 502 with additional search terms such as the traveler's history of prior lodging along interstate highways including the average price paid by the traveler for such lodging.

Keyword bids are concurrently received from MBRS 160 in step 510. Keywords are words selected by the MBRS with the intent of matching search terms received in steps 501, 502 and thus may relate to the location of LAD 110, merchant location 162, route 152, traveler preferences 122, RTT 154 (ETA), and other information. Keyword bids represent the price the merchant is willing to pay when the merchant's selected keywords match search terms received in steps 501, 502, and 503 and result in a billable event such as described in FIG. 14.

In step 521, auction server 147 narrows the plurality of merchants eligible to participate in the GSP auction to those whose location and keywords received at step 510 match the search terms generated from steps 501, 502 and 503. Continuing with the Breezewood example above, the keywords “sixty miles,” “Breezewood” and “Pennsylvania Turnpike” and “headed south to Washington, D.C.” (which can be expressed as a known or hypothetical route) could operate to narrow responsive merchants to twenty eligible motels located in the general vicinity of Breezewood.

Auction server 147 applies the keyword bids received in step 510 to order merchant alerts in a message queue in step 522. In this embodiment, generation of the message content of merchant alerts is reserved until step 532.

Step 522 is followed by reverse auction 530, further described in an embodiment at FIG. 4. In a reverse auction, sellers compete against one another to win the business of buyers by lowering their respective prices or offering free or discounted amenities. To minimize the number of traveler alerts, in this embodiment bidders (merchants) are public to the buyer; bids are sealed, i.e., private to the competing merchants during the auction, merchants are restricted to initial bids once the auction begins, and the auction is limited to a predetermined amount of time during which the traveler may respond However, as one of ordinary skill may appreciate, a reverse auction may be constructed in several different ways, including allowing merchants to modify their auction bids as the auction proceeds.

Business rules are received from MBRS in step 511. A business rule is any set of electronic directions provided by the merchant that generates and modifies the content of auction offers intended for initial or follow-up transmission to one or more LAD 110 consistent with the merchant's business objectives. For example, a business rule could automatically modify the discount on motel rooms offered by the merchant to the traveler based on the traveler's location and estimated time of travel or undercut a room rate offered by a competitor. Business rules are then applied in step 531 to generate auction offer content in step 532 for each of the alert offers previously ordered in step 522. The revised alerts are then transmitted from the traveler alert server 140 to LAD 110 in step 533.

In step 534, an auction timer set to a predetermined time is started upon transmission of the alerts in step 533. In one embodiment, a countdown is also started on LAD 110 (see warning 218 of FIG. 4).

In step 535, if an auction selection is received from the LAD while the auction timer is active, then the auction selection is directed to the winning merchant at step 537 for further processing, and the auction timer stops. If an auction selection is not received from the LAD during the predetermined time set by the auction timer, the auction timer is stopped in step 536 and the auction is shut down.

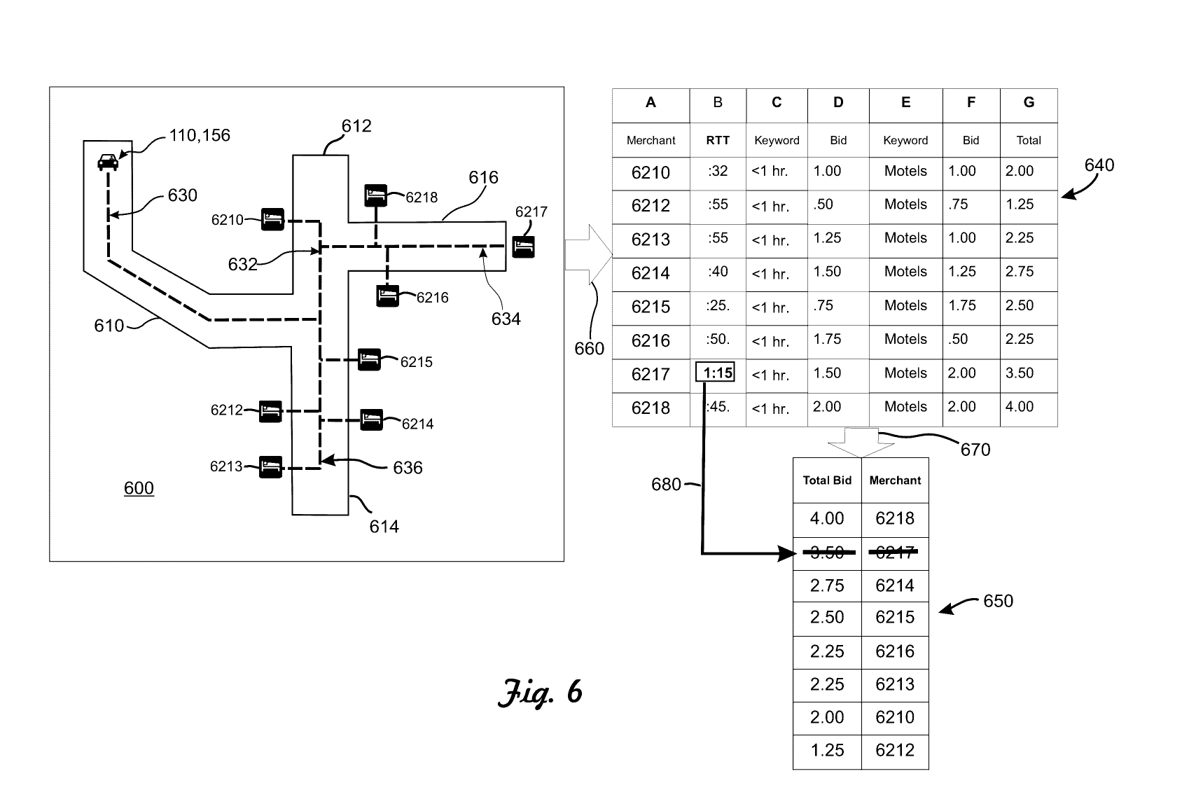

FIG. 6 shows example operation of auction server 147 of FIG. 1 implementing GSP auction 520, FIG. 5, where merchants bid based on RTT of LAD 110 to each of the merchant locations (e.g., merchant location 162) stored in MLSL 146. In particular, FIG. 6 shows a map 600 and two tables 640 and 650. Map 600 illustrates information used by ETA/RTT resolver 143 to determine RTT 154 of LAD 110 to each of merchant locations 6210, 6212, 6213, 6214, 6215, 6216, 6217, and 6218. The location 156 of LAD 110 represented herein by automobile icon, known or hypothetical routes 630, 632, 634, and 636 that LAD 110 may travel, merchant locations 6210, 6212, 6213, 6214, 6215, 6216 along the routes, and routing attributes 610, 612, 614 and 616 (e.g., roadways or the names of roadways). Merchant locations 6210, 6212, 6213, 6214, 6215, 6216, 6217, and 6218 may be based on geocoded addresses that are stored in MLSL 146 and correlated to road and other path data stored in map data server 144.

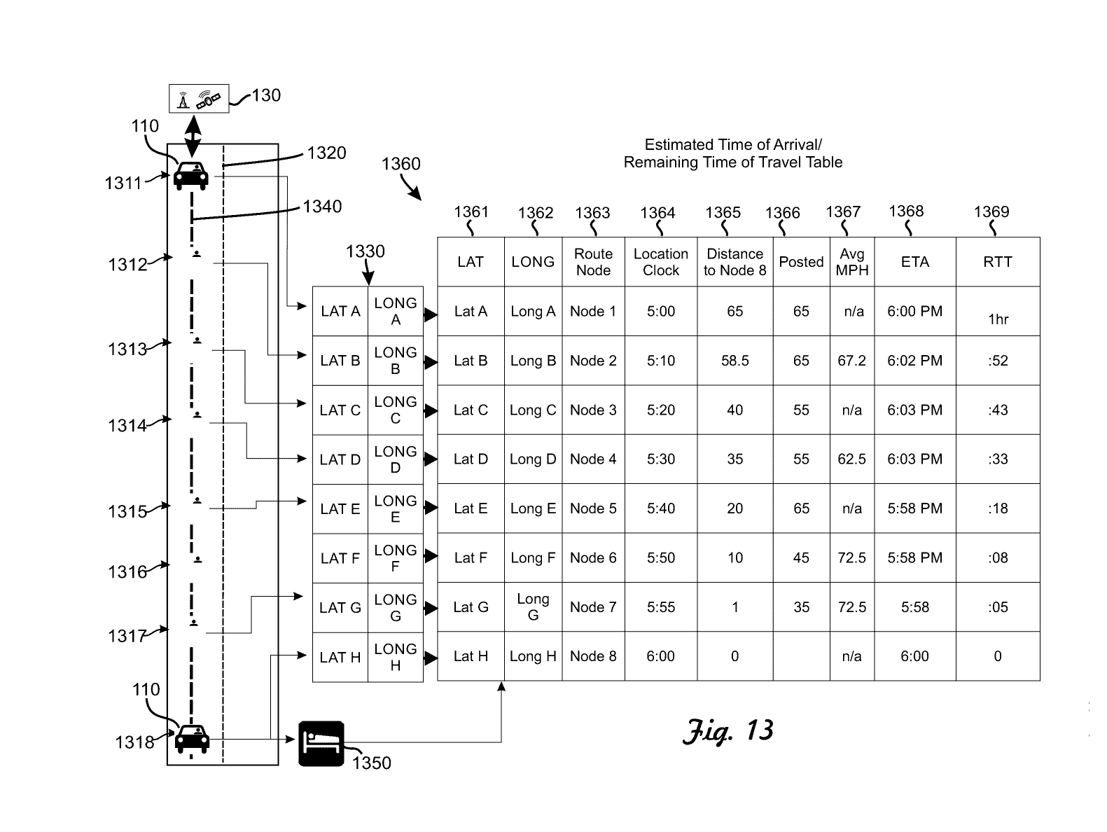

Auction server 147 stores information of bids received from MBRS 160 in table 640 according to columns A through G. Column A stores the merchant ID, which for clarity of illustration shows labels of merchant locations 6210 through 6218 from map 600. Column B stores RTT for LAD 110 to reach the corresponding merchant location of column A, as further illustrated in the example of FIG. 13. Column C stores a keyword (e.g., criteria) corresponding to the RTT of column B as defined by the merchant, e.g., “less than one hour.” Column D stores a bid value (e.g., $1) defines by the merchant for when the keyword of column C is matched. Column E stores a preference keyword (e.g., “motel”) that would be matched to a keyword “motel” inputted by the traveler using LAD 110 as shown in the example of FIG. 2. Column F contains a bid value corresponding to when the keyword of column E is matched. Column G stores a corresponding total bid value that results when both keywords of columns C and E are matched. In the example of FIG. 6, bids corresponding to eight merchant locations 6210, 6212, 6213, 6214, 6215, 6216, 6217, and 6218 have keywords as shown in columns C and E are entered into a generalized 2^{nd} price auction when LAD 110 is within one hour RTT (e.g., driving time) from their respective locations and the traveler using LAD 110 has entered preferences including the keyword “motel”.

In this embodiment, at least one bid is required with respect to the RTT of LAD 110 to the corresponding merchant location and the merchant's RTT keyword (i.e., column C) must match or exceed the determined RTT of column B, otherwise, as indicated by arrow 680, the bidding merchant is excluded from the auction as further described below. Auction server 147 generally follows the rules of a GSP auction with a modification imposed by the RTT keyword bid, the relevance of which is determined by the physical location of LAD 110 and determined RTT to the merchant location.

This restriction is illustrated in auction results table 650, which is based upon auction table 640. As noted above, in table 640, Column A displays eight merchant locations 6210-6218 that have submitted keywords and bids. The merchant's RTT keyword and related bid are represented in columns C and D, respectively. As the auction is conducted, auction server 147 uses ETA/RTT resolver 143 to determine the RTT for each corresponding merchant location, as stored in column B. In this example, all merchants have defined a keyword bid in column C that requires LAD 110 to be less than one hour from the merchant location. Where the RTT of column B is greater than the defined keyword of column C, i.e., greater than one hour, the corresponding bid is not entered, as shown by arrow 680, into auction results table 650.

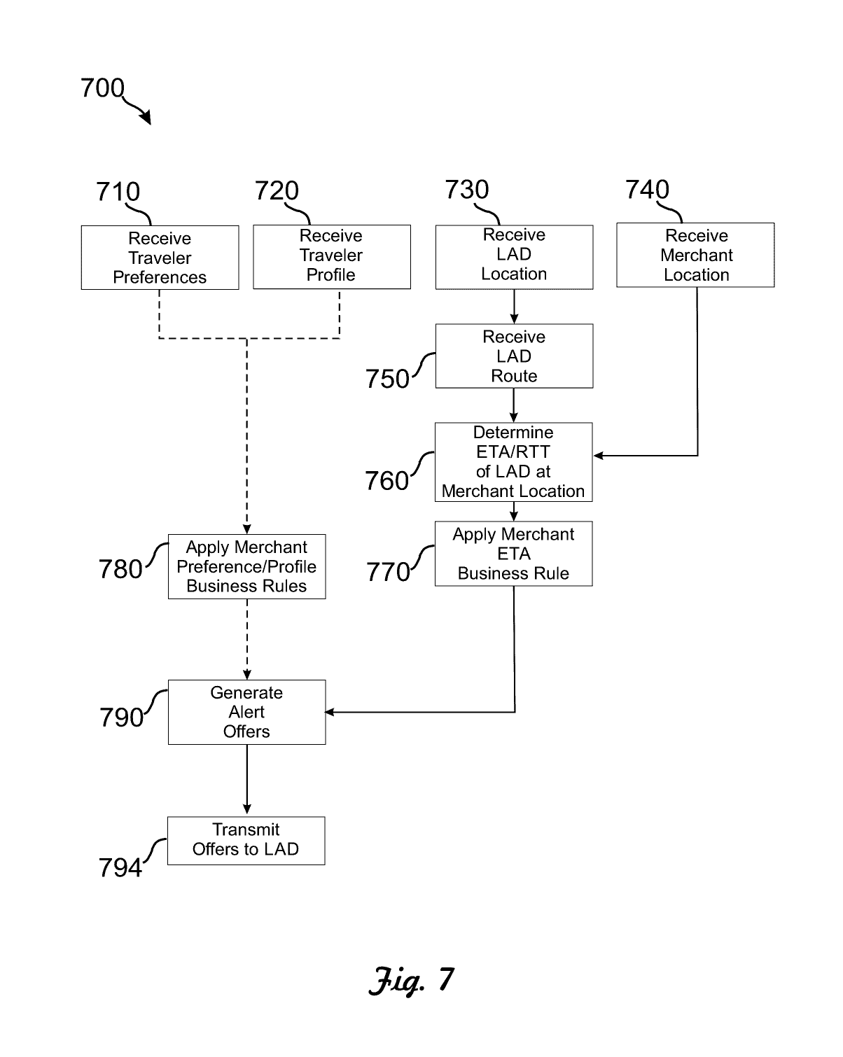

In the example of table 640, column E shows a preference keyword of “Motels”. While one or more preferences, profiles, or routecentric keywords may be considered, none of these additional keywords is required to be entered into the auction. As indicated by arrow 670, auction server 147 combines the RTT keyword and keyword bids with the example keyword and orders the alerts of table 650 according to an example generalized second price auction as detailed in the following description and as can be modified by artisans of ordinary skill. As shown in FIG. 7, the GSP auction may be then followed by a reverse auction.

The GSP auction starts with the last bid placed by the merchant corresponding to merchant location 6218 for the keywords “lodging” and remaining travel time of “less than one hour.” Mathematically, for a given keyword, there are N positions on the screens, where ads related to that keyword may be displayed, and K bidders (merchants). Positions are ranked or queued based on the bids in descending order: for example, for any alert position i and alert position i2 such that i<i2, there is ∝i>∝i2. That is, for merchant k and merchant l such that the merchant k's alert position is in front or above the merchant l's alert position in the message queue, the probability of clicking on merchant k's alert is greater than the probability of clicking on merchant l's alert. Positions are labeled in descending order: for any i and j such that i<j, ∝₁>∝ⱼ.

The order of alerts displayed on the LAD 110 is important because the traveler does not always have the luxury of browsing, as would be the case in an Internet search auction, especially while driving. System 100 is for example, incorporated into and programmed as a feature of “smart car” technology where preferences may be predetermined and alerts received automatically without requiring further traveler interaction. In one embodiment, alerts are provided by voice. While the alerts may be repeated, e.g., the voice alerts may be recorded and played back one or more times, generally travelers (i.e., the users of LAD 110) make decisions relatively quickly.

The GSP auction then works as follows: t for either the traveler or the LAD 110 enters or generates a given keyword, e.g., remaining time of travel and/or lodging, and, for each k, merchant k's last bid submitted for this keyword prior to t is bₖ; if merchant k did not submit a bid, bₖ=0. Let b^{(j)} and g(j) denote the bid and identity of the j-th highest merchant. If several merchants submit the same bid, they are ordered randomly.

In an important difference as compared to An internet advertising auction, auction server 147 only includes merchants whose locations are within the RTT range of the LAD 110 in identifying the bid and identity of the j-th highest merchant, wherein location-based key words are automatically and dynamically generated by the traveler alert system 100, e.g., ETA/RTT resolver determining the remaining time of travel based the location, speed, speed limit, and other factors affecting the calculation.

Auction server 147 then allocates the top position (i.e., the first listed alert on LAD 110) to the merchant with the highest bid, g(1), the second position to g(2) down to position min{N, K}. If a traveler clicks on an advertiser's link, the advertiser's payment per click is equal to the next advertiser's bid. So merchant g⁽ⁱ⁾'s total payment p⁽ⁱ⁾ is equal to ∝ᵢb⁽ⁱ⁺¹⁾ for I 0 {1, . . . min{N, K}}.

In the typical Internet business model involving a GSP auction, the bidder is typically charged the cost of a particular bid when a user clicks on a link contained in the bidder's advertisement that takes the user to the bidder's website, commonly referred to as click-through-rate (CTR). The charges generated under GSP auction 520 are similar to the Internet CTR where the merchant is only charged if the traveler clicks on an alert. However, other business models are appropriate without departing from the scope hereof.

Artisans of ordinary skill would understand that the GSP auction may be internally or externally modified, e.g., through an adaptation of the Vickrey-Clarke-Groves (VCG) auction or an English auction without departing from the scope hereof.

FIG. 7 is a flow chart illustrating one example method 700 for transmitting merchants' alert offers or advertisements to LAD 110 of FIG. 1 from the traveler alert server 140 based on the RTT or ETA of the LAD 110 along a known or hypothetical route that terminates at or passes near a merchant location.

In contrast to prior art that defines the relationship of merchants to the traveler based only on their respective locations or that emphasizes the time of travel from the traveler to the merchant for the benefit of the traveler, FIG. 7 emphasizes the temporal relationship of the traveler to the merchant where the RTT benefits the merchant in a reverse auction. RTT and its equivalents (e.g., ETA) are preferable to a geo-fence or a defined distance because it more accurately correlates the traveler to the merchants' business requirements, e.g., bookings or restaurant reservations. Merchants may experiment with various reverse auction offers by adjusting the RTT keyword. For example, the later in the evening a driver seeks lodging, the more anxious that driver may be to turn in, thus the higher the offer made based on the driver's estimated time of arrival. Indeed, a feature of merchant advertiser rules defined within MBRS 160 is the ability for the merchant (e.g., an inn keeper) to tailor offers based on percentage of current capacity. Thus, the defined RTT may be structured in intervals suitable to the business. For example, a restaurant may find it desirable to provide reservations according to an RTT with fifteen minute intervals or even less or based on an internal algorithm that determines when the next table may become available.

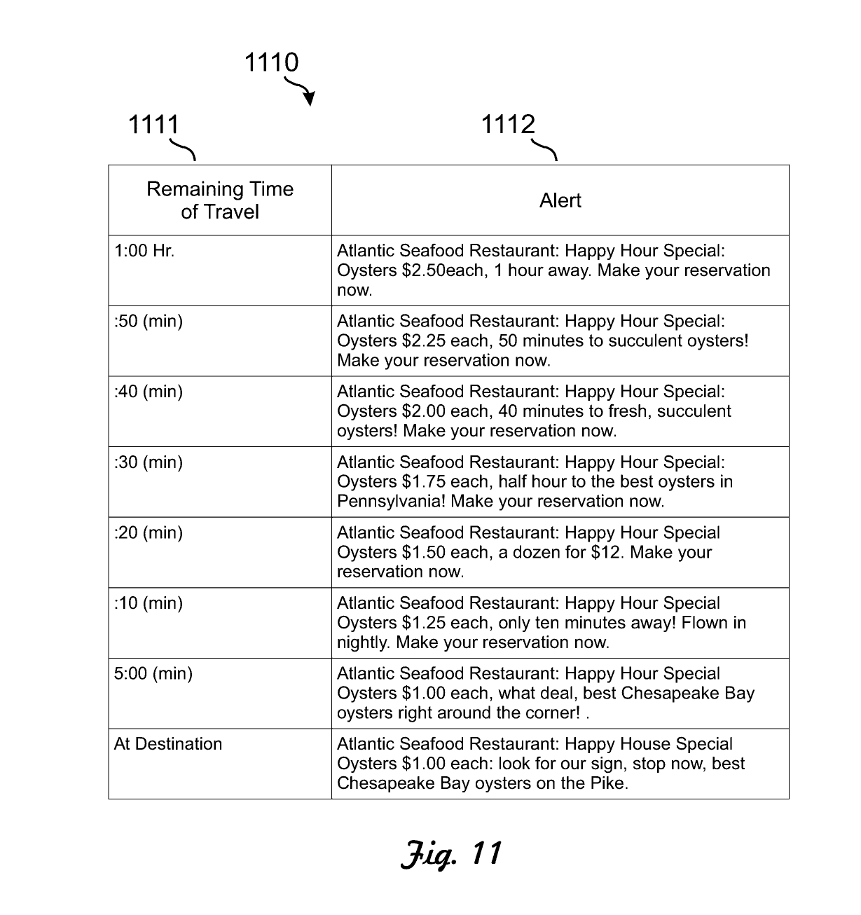

Method 700 combines traveler preferences 122a of FIG. 1, received in step 710, with traveler profile 142 received in step 720 location of LAD 110, received in step 730, and merchant location 162 received in step 740 to generate alert offers 124b in step 790. More specifically, ETA/RTT Resolver 143 of traveler alert server 140 receives the location of LAD 110 in step 730, the route of the LAD 110 in step 750, the merchant location in step 740 and determines RTT 154 in step 760. The locational information, typically in the form of latitude/longitude coordinates along vectors to represent the route, is used to determine the ETA or RTT of LAD 110 to the merchant location. An example of how the RTT is determined in step 760 is illustrated in FIG. 13; however, numerous ways to determine RTT of LAD 110 along a route are known to artisans of ordinary skill in the art, and any one of which may be appropriately incorporated into embodiments hereof Once the RTT is determined, ETA/RTT resolver 143 passes the RTT specific to LAD 110 to alert generator 148, which, in step 770, applies the applicable merchant RTT business rule received from MBRS 160 to generate alert content specifically related to the RTT for LAD 110. Sample alert content is illustrated in FIG. 11 and may change dynamically according to the remaining time of travel for each traveler as the traveler approaches the merchant's location.

The more a merchant knows about the traveler using LAD 110, the more relevant the offer made by the merchant can be. Thus, when available, traveler preferences received in step 710 and traveler profiles received in step 720 are incorporated into content generated in step 780. The content generated by both steps 770 and 780 is then combined by alert generator 148 in step 790 and transmitted to LAD 110 in step 794.

The generalized second price auction and/or the reverse auction may be bypassed when the number of merchants or merchant alerts are insufficient justify either auction.

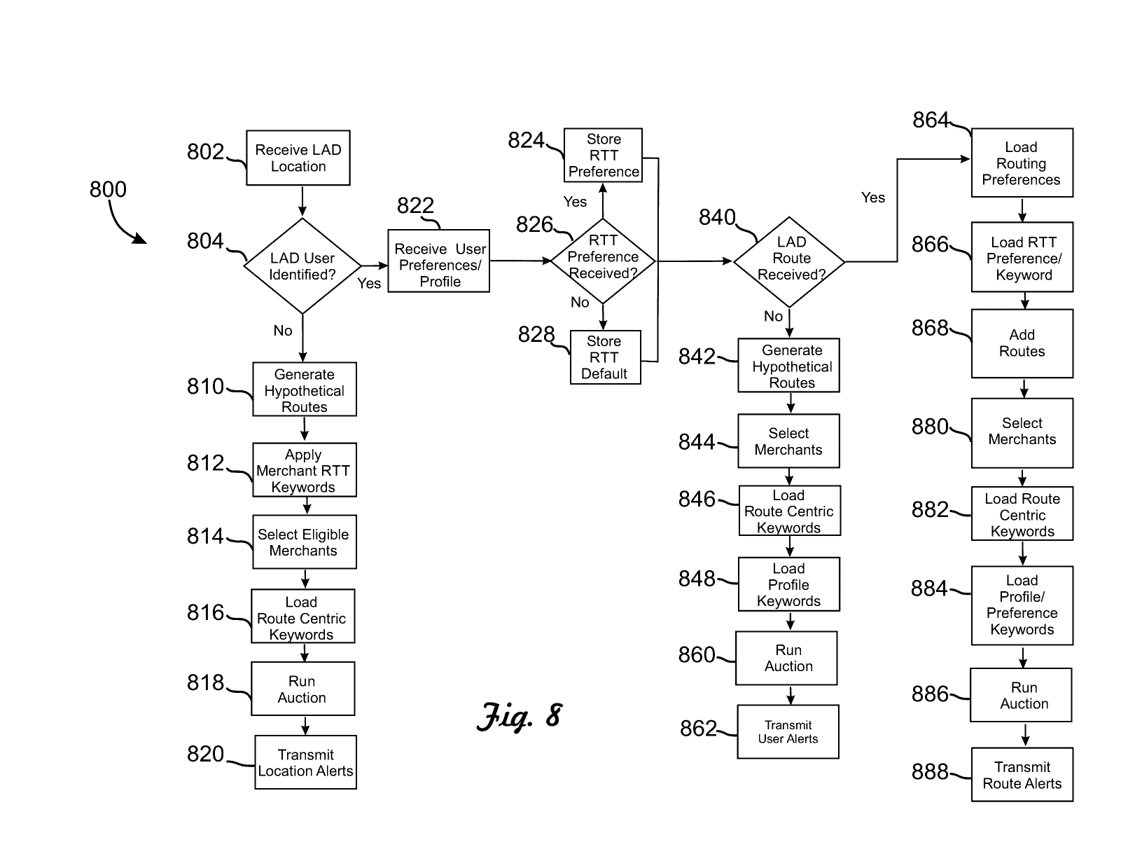

FIG. 8 illustrates one example method 800 for applying RTT) of LAD 110 of FIG. 1 as a keyword to select merchants eligible to provide alerts to LAD 110 and then as one of one or more keywords in a generalized second price auction to order the advertising alerts. Method 800 may be implemented within traveler alert server 140 to process signals received from LAD 110.

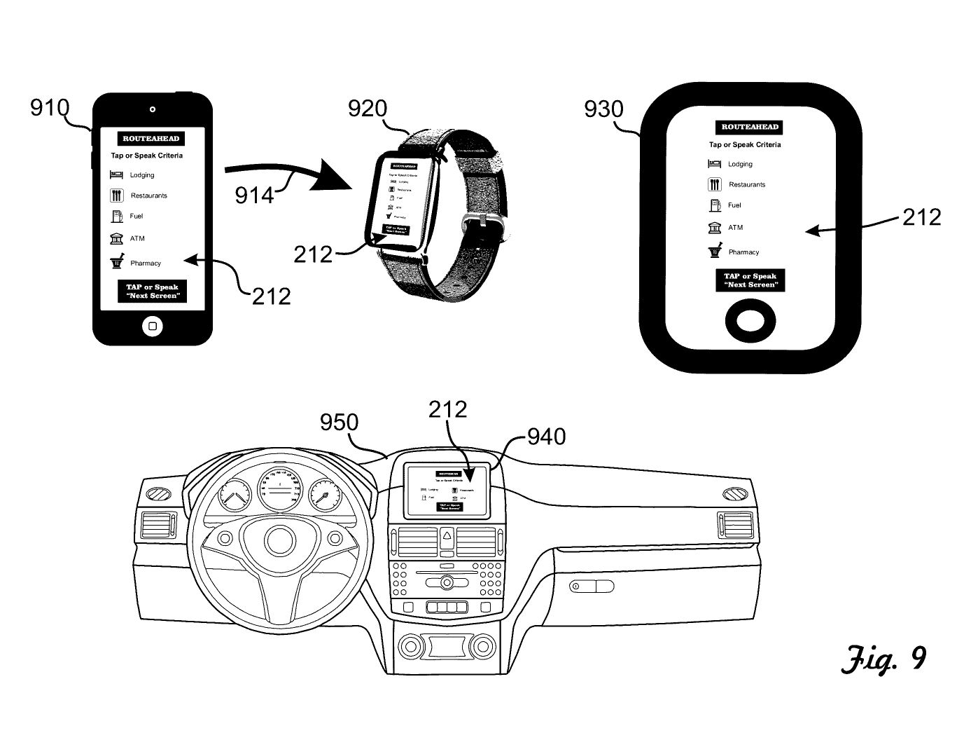

Traveler alert server 140 receives the location of LAD 110 in step 802. Typically, the location of LAD 110 depends on whether its locational aware system FIG. 1 130 has been activated and the necessary permission to track the LAD 110 has been directly or indirectly granted by the traveler using LAD 110. LAD 110 may be configured in any number of devices known to artisans of ordinary skill. For example, Lad 110 may be implemented as one or more of 1) a portable device, 2) an in-dash system, and 3) a feature of prevailing self-driving car technology, where a programmed key or switch automatically or manually grants the necessary permissions and other information as needed. Example configurations are shown in FIG. 9.

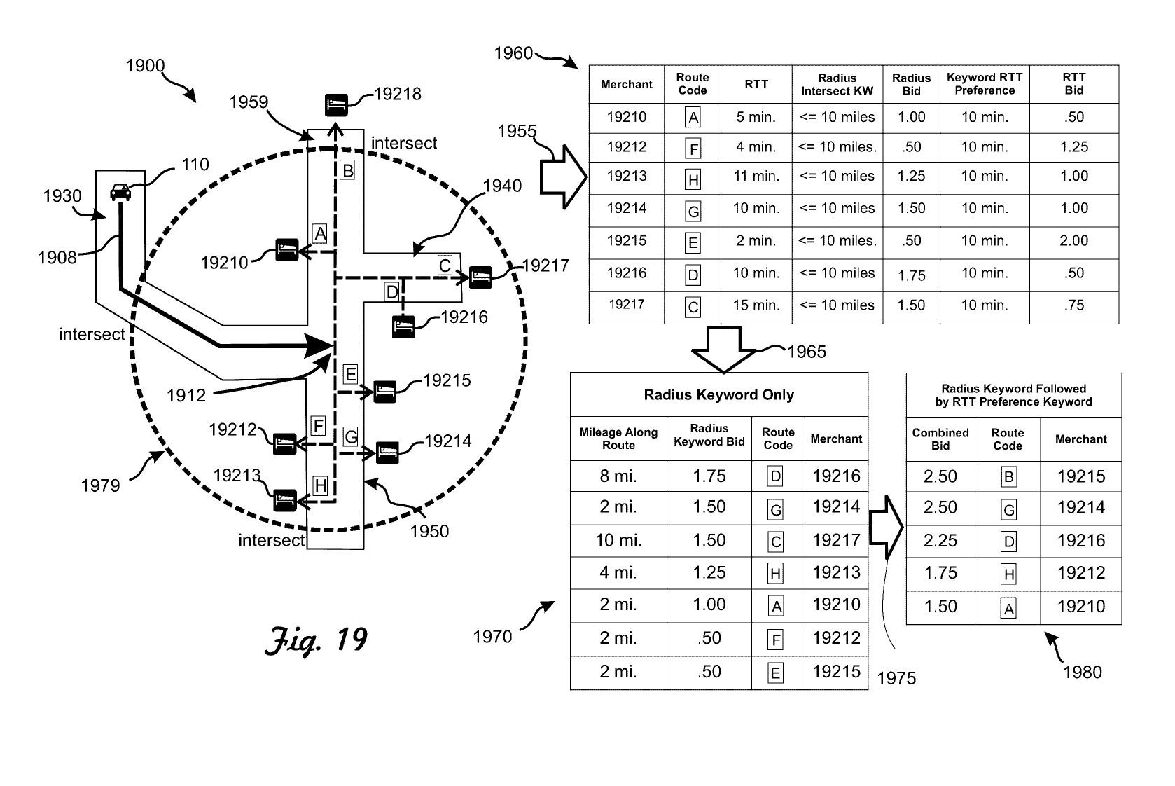

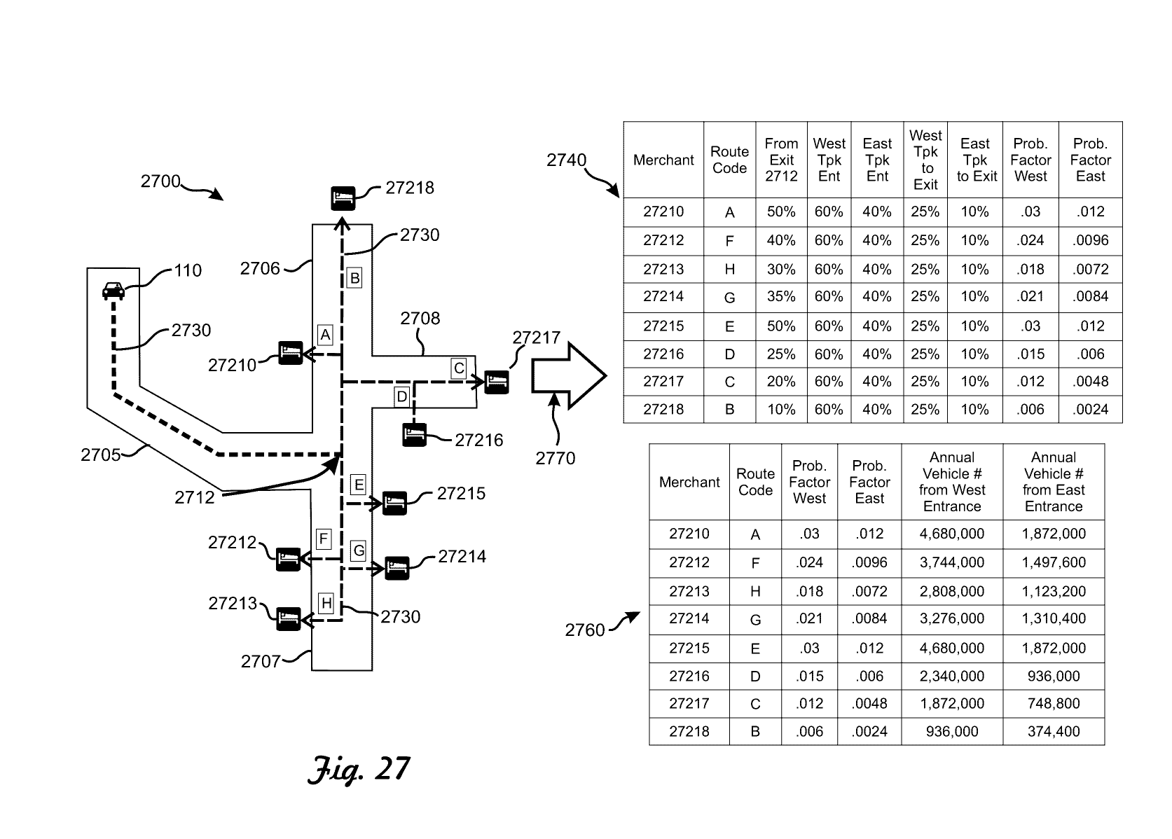

In step 804, method 800 determines whether the traveler using LAD 110 and/or an associated traveler profiles 142 has been identified. Such identification may be supplied indirectly or directly through a traveler log-in, or embedded permissions granted to access the traveler profile or other relevant information stored in LAD 110 through an application such as Google Now, or other identification techniques commonplace to today's portable communications technology. Where route information is not received from LAD 110, map data server 144 generates one or more hypothetical routes in step 810. Hypothetical routes may include roadways, sidewalks, hiking trails, subway lines, air routes from which RTT of LAD 110 may be calculated. Hypothetical routes may be determined by any number of methods alone or in combination, such as overlaying an arc, polygon or radius upon a prospective heading of the LAD 110 as shown in FIGS. 19, 22 and 23. Because it is impractical to process every conceivable route from a certain location, map data server 144 may be programmed to supply a default RTT and to determine vector travel paths, optionally relying on traffic flow analysis to determine the statistical likelihood of LAD 110, when at a certain location, of travelling along a certain path, such as shown in FIG. 27.

Alternatively, RTT defaults may be based on travel mode or combination of travel modes. For example, the default RTT of a pedestrian may be correlated to convenient walking distance, or 15 minutes. The default RTT of a taxicab may be one hour. The default RTT of a motorist may be two hours.

Rules from MBRS 160 are then processed in step 812 to apply the merchant RTT keywords. In step 814, in general, only bids from merchants whose locations, stored in MLSL 146, fall along the hypothetical route and that fall within the default RTT are eligible to participate in the subsequent auction in step 818. However, where a number of merchants are excluded because their locations along the hypothetical routes do not fall within the defined RTT of Lad 110, system 100 may regenerate hypothetical routes based on a revised RTT.

Merchants may supplement RTT keyword bids with routecentric keyword bids (e.g., see FIG. 14), such as one or more of: a direction of travel, a location along a pre-selected road segment, a route number, a street name, a destination, and a time of day. For example, merchant A may target alerts to only LADs (e.g., LAD 110) located on the Pennsylvania Turnpike with an RTT of one hour to the corresponding merchant location, whereas merchant B may wish to target LADs (e.g., LAD 110) that are within fifteen minutes RTT of the corresponding merchant location, irrespective of the route taken. Where the location of LAD 110 is on the Pennsylvania Turnpike, the additional bid of merchant A operates to order, or prioritize, alerts from that merchant before alerts from merchant B. However, where LAD 110 has an RTT of 15 minutes from the corresponding merchant location of merchant B at the time the auction is conducted, alerts of merchant B take precedence over alerts of merchant A when the location of LAD 110 is not on the Pennsylvania Turnpike. Where the location of LAD 110 is both on the Pennsylvania Turnpike, satisfying keywords of bids of merchant A, and also has an RTT of fifteen minutes to the merchant location of merchant B, thereby satisfying keywords of merchant B, the alert order may be resolved based upon the total bid value (e.g., highest bid wins); and where the total bid values are the same, the alerts may be ordered randomly.

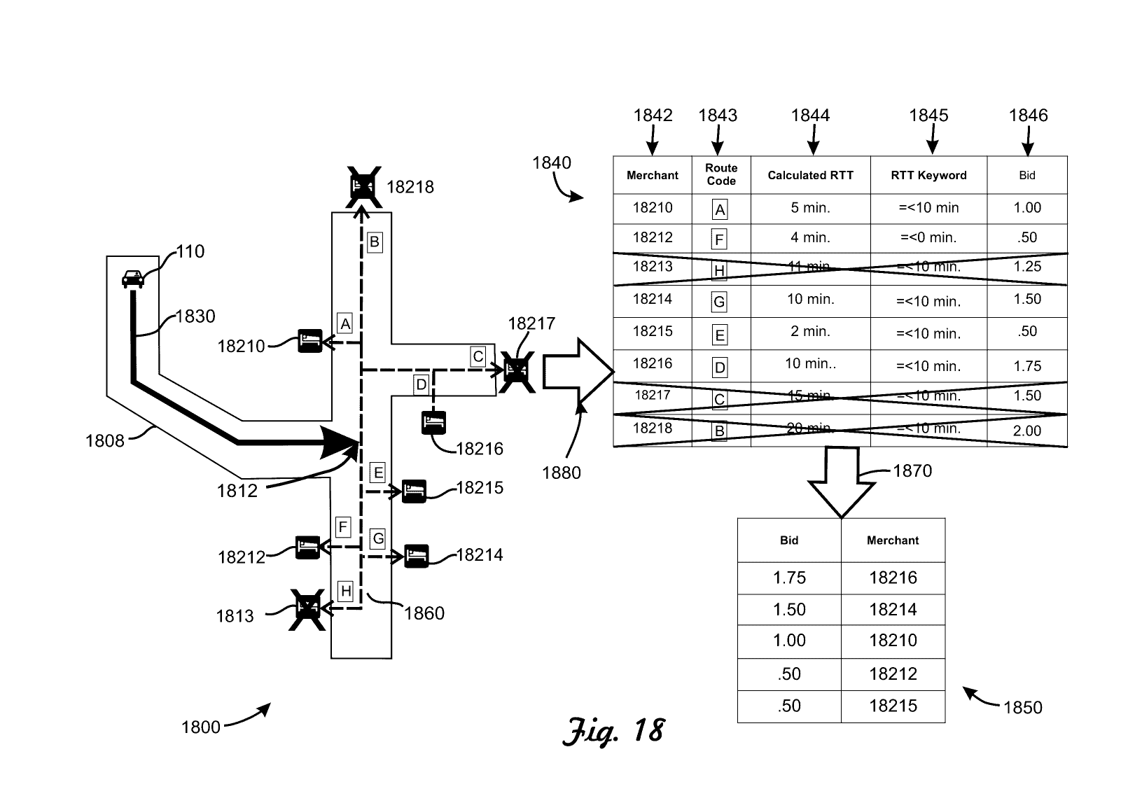

In step 818, method 800 processes RTT keywords and additional routecentric keywords in a GSP auction, treating the RTT keywords as equal and ordering results based on bid price. Where no supplemental routecentric keywords are received, the resulting message queue positions merchant A's bid of $2 on a three hour RTT ahead of merchant B's bid of $1 for an RTT of fifteen-minutes, ordering the alerts accordingly. On the other hand, where merchant A bids $1 for an RTT of three hours and merchant B bids $1 for an RTT of fifteen-minutes, both alerts will be ordered randomly. The specific mechanics of step 818 are further shown in FIGS. 6 and 18.

If routecentric keywords have been received in step 816, the auction server 147 combines the RTT and additional routecentric keyword bids, orders the merchant alerts, and in step 820, method 800 passes the alert message queue as described in FIGS. 5 and 6, to alert generator 148 to generate and transmit the traveler alerts to LAD 110.

In step 812, and as shown in step 770 of FIG. 7, MBRS 160 may aid the merchant in determining how much to bid on specific keywords by determining the statistical probability that LAD 110, whose route is unknown, may pass in proximity to a certain location, relying in part on public traffic flow data, the traveler profile, or real-time feedback from use of system 100, as shown in FIG. 27. For example, a merchant having a merchant location at the Breezewood Exit 181 of the Pennsylvania Turnpike wishes to participate in an advertising auction directed to motorists headed in either direction. Travel statistics indicate that 15% of travelers entering the Turnpike at 6:00 PM at the Westgate exit will take the Breezewood exit two hours later; and 25% of all travelers within 60 miles of Exit 181 at 6:00 PM will eventually take the Breezewood exit between 7:00 PM and 8:00 PM. The merchant may thus vary associated keyword bids (rules) based on these statistics. The merchant may manually enter keywords and keyword bid changes based on actual experience, and/or may utilize algorithms to adjust keyword bids automatically using real-time feedback of auction results.

Where, in step 804, the traveler using LAD 110 is identified, method 800 continues with step 822 to receive traveler preferences and to update the traveler profile stored in traveler profiles 142. Step 826 determines whether the traveler's RTT preference or the system's default RTT is used to generate routes and select merchants. If in step 826 an RTT preference is not received, then step 828 generates and stores a default RTT to be used to generate hypothetical routes in step 842. Where an RTT traveler preference is received, it is stored as a searchable keyword for later use, e.g., for use in step 866, or for use as a routecentric keyword in step 846.

More specifically, where traveler RTT preferences are not received in step 826 and LAD 110 route is not received in step 840, map data server 144 is invoked to generate one or more hypothetical routes. In steps 842, 844 and 846, method 800 then loads routecentric keywords, as described above, except that traveler profile keywords received in step 822 are loaded in step 848. In step 860, method 800 invokes auction server 147 to run a GSP auction to order alerts, and in step 862, method 800 invokes alert generator 148 to transmit traveler alerts to LAD 110.

Alternatively, where a traveler RTT preference is received, but step 840 determines that the route of LAD 110 is unknown, method 800 applies the traveler preference RTT to generate one or more hypothetical routes in step 842 and to locate and select, in step 844, only merchant locations on which any merchant RTT bid is equal to or less than the preference. However, operators of system 100 may adjust the RTT or RTT range where preference results in an insufficient number of bids to generate a meaningful auction.

If, in step 840, method 800 determines that the route of LAD 110 was received, then method 800 continues with step 864 to load the traveler's routing preferences and/or the traveler's RTT Preference. In step 866, method 800 loads the merchant RTT Keywords, as described above. Routing preferences may include driving time required to reach a certain location “off-route” or type of road, e.g., “scenic.”

ETA/RTT resolver 143 analyzes the additional routes added in step 868 (e.g., as generated by map data server 144 based upon the routing preferences loaded in step 864) and in step 880, method 800 selects merchants eligible to participate in the GSP auction. In one example of step 880, if the traveler's RTT preference is received in step 824, auction server 147 selects only those merchants whose remaining time of travel bids are equal to or less than the traveler preference. Otherwise, the auction server determines all of the merchant RTT bids that correspond to the location of LAD 110 along the defined route(s) or hypothetical route(s) generated by map data server 144.

In step 884, profile and preference keyword bids are loaded from MLSL 146. In step 886, method 800 invokes auction server 147 to run either, or both, of a GSP auction and a reverse auction, transmitting alerts to LAD 110 in step 888 as shown in FIG. 5.

FIG. 9 shows example implementations of LAD 110 of FIG. 1. LAD 110 may be implemented as one or more of: a smartphone 910, a smartwatch 920, a tablet 930, and a vehicle-based display 940 integrated into a vehicle's dashboard 950. With the exception of vehicle-based display 940, each of these devices share a common feature: portability. While desktop computers and laptops may also be used, traveler alert system 100 is optimally configured to track the traveler's actual, intended, and hypothetical location/movements, whether traveling in a car, on foot, on a train, or on an airplane, and thus system 100 operates optimally when LAD 110 is implemented as a portable device.

The integrated capabilities of an operating system (e.g., Apple iOS, Google Android, and Microsoft Windows) of smartphone 910 are known to artisans of ordinary skill and meet all of the input, output, and locational requirements of LAD 110 (e.g., include a digital display, a built-in GPS, an assisted GPS, WiFi capability, cellular triangulation capability, beacon, Bluetooth, etc.). Such devices may also include a microphone, a speaker, voice recognition technology, personal profile storage, wireless communication, real-time updates, access to remote databases, and accelerometers to measure footsteps and speed. In one embodiment, functionality of LAD 110 is incorporated into an app that may be downloaded to and executed on smartphone 910. Smartphone 910 may also operate as a phone, which may be used by traveler alert system 100 to auto-dial alerts or consummate transactions directly with the merchant.

Smartwatch 920, at a current level of technology, may or may not have integrated GPS capability and the ability to operate as a cellphone, but at least it includes an accelerometer, voice recognition, and a touchscreen digital display. To be fully functional with respect to location-enabling and cellphone use, smartwatch 920 may cooperate with a compatible smartphone (e.g., smartphone 910).

Tablet 930 has many features in common with smartphone 910, often excluding only phone call capability. The distinction between smartphone 910 and tablet 930 has increasingly blurred as smartphones increase in size.

Vehicle-based display 940 features all of the benefits of the smartphone with the exception that its use is typically restricted to operation within an automobile, motorcycle, or bicycle. Vehicle-based display 940, together with onboard WiFi or Bluetooth capability, may include many of not all functionality of smartphone 910, as well as benefiting from direct integration into the automobile's computer system, which may monitor and automatically detect both internal and external events affecting the driver and the car, e.g., fuel consumption, condition of the car's operating systems, road conditions, and weather, all of which may be converted into search terms or keywords for use with system 100. The car's onboard computer may facilitate integration of vehicle-based display 940 into existing and future self-driving and smart-car technologies. Thus, real-time relevant information may be automatically added to the traveler's profile and in turn employed (as keywords) within traveler alert system 100, including automatically generating routes and self-driving instructions as required.

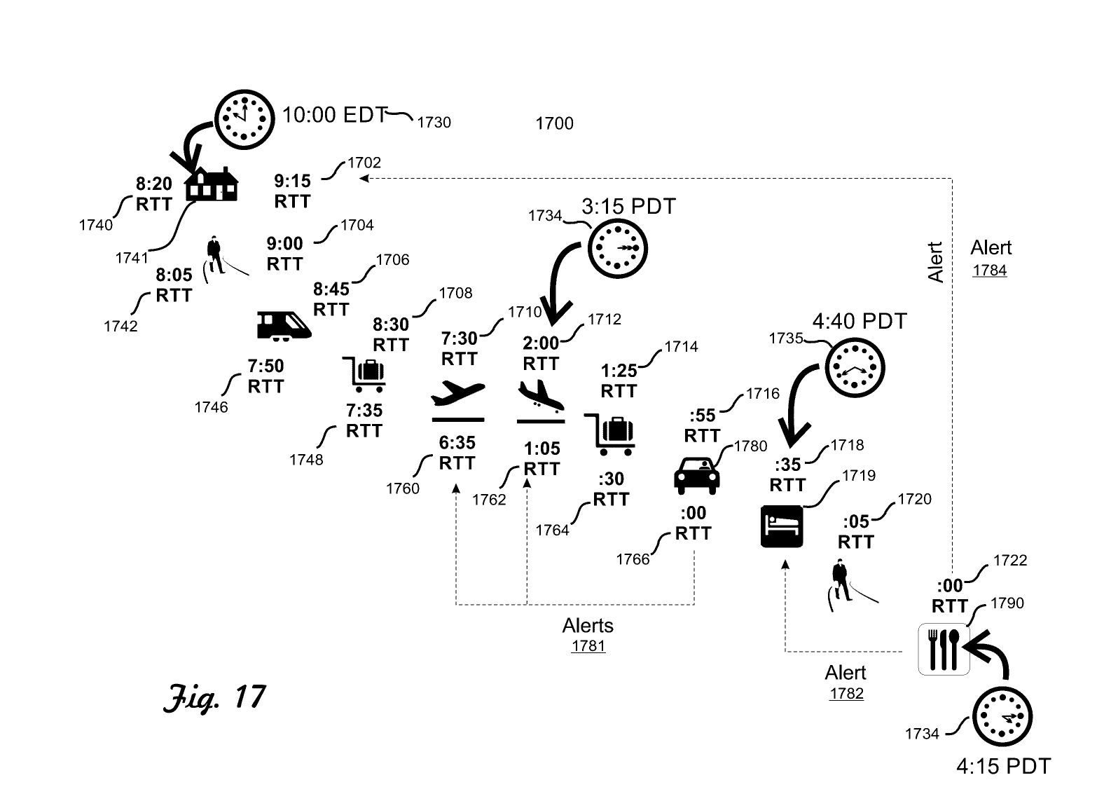

Some or all functionality of vehicle-based display 940 may be replaced by smartphone 910, smartwatch 920 and/or tablet 930 through wireless and/or direct connection to the automobile's onboard computer. For example, a cradle may be used together with a smartphone application that communicates seamlessly with the car's computer system. Similarly, wired or wireless connections may be made to other modes of transportation, including airplanes, trains, taxicabs, or other public conveyances, to more fully automate the process of collecting location-relevant keywords, in particular satisfaction of the multi-modal features described in FIG. 17.

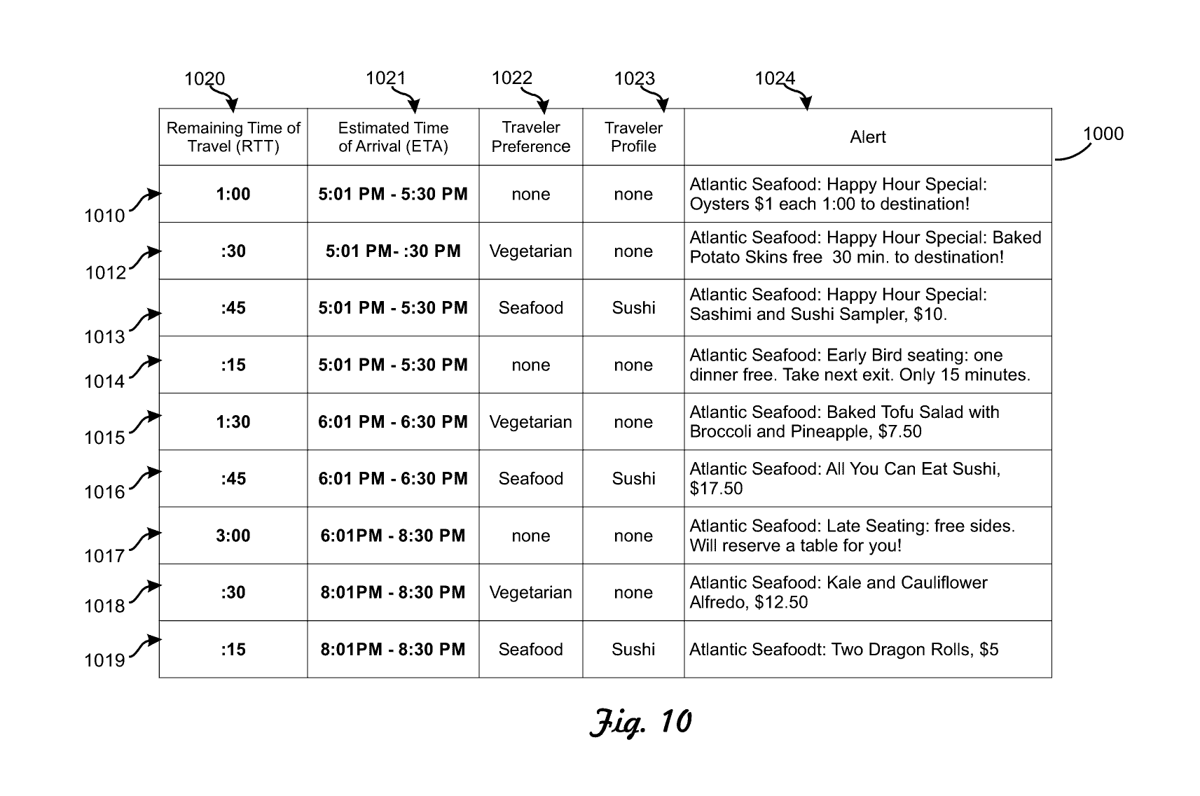

FIG. 10 is a table 1000 illustrating example content generated by MBRS 160 of FIG. 1 responsive to two routecentric keywords, estimated time of arrival (ETA) 821, remaining time of travel (RTT) 1020, and two non routecentric keywords, traveler preference 1022 and traveler profile 1023.

Although ETA 1021 and RTT 1020 are different expressions of the length of travel time (TOT) of LAD 110 to travel from its current location to a relevant destination, either expression may be qualitatively and circumstantially different. For example, ETA is of greater importance to a merchant, such as for managing reservations of a restaurant, and RTT is of greater importance to the traveler who is tired after a long drive. Also, a merchant owning a restaurant or motel may modify incentives based on how long it will take a traveler to reach the restaurant or motel location. For example, the merchant may send a traveler only five minutes driving time from the restaurant an alert that is different to an alert sent to a traveler one-hour driving time from the restaurant.

In the example of FIG. 10, row 1010 of table 1000 shows how a restaurant generates a generic “Happy Hour” alert offering a $1 oyster special to a traveler whose ETA (column 1021) indicates arrival between 5:01 PM and 5:30 PM. Alternatively, the restaurant may modify the message based on the travelers' RTT 1020, such that the offer changes as the traveler draws closer, as shown in column 1024

Keywords defined within traveler preference 1022 and traveler profile 1023 allow the restaurant to tailor alerts 124 to a specific traveler. For example, row 1016 targets a traveler indicating a preference 1022 of seafood, and having a but a profile 1023, informed by a third party database tracking grocery purchases and updated at the time the alert is generated, indicating frequent purchases of sushi, by sending an alert 124 offering “All You Can Eat Sushi” for $17.50.

FIG. 11 is a table 1110 showing further example adjustment of alert content 1112 based upon merchant advertiser rules corresponding to RTT 1111. These rules may be applied at any time as a merchant advertiser rule, (see for example step 770 of FIG. 7 and step 511 of FIG. 5) where RTT to the merchant location has been determined as described above. In this example, as the RTT 1111 decreases by 10 minute intervals, the corresponding alert content 1112 is changed.

Generally, system 100 transmits an alert just once upon receipt of the location of LAD 110 and corresponding calculation of its RTT. However, system 100 may successively transmit alerts to LAD 110 according to the intervals shown, varying content according to the business rules supplied by the merchant. In this way, the merchant may experiment with various alert patterns to determine which pattern yields the more satisfactory results. In one example, a merchant may transmit alerts 124 without any change in price but including different descriptive inducements. In another example, a merchant may randomly vary the price. In another example, a merchant may send the same alert repeatedly, but then drop the price as the traveler approaches the merchant location. In this way, the merchant has complete control over the timing and content of alerts based on the estimated RTT for locations of travelers on a route that passes by or near the merchant location.

In certain embodiments, keywords embodying RTT, ETA or time of travel (TOT) of LAD 110 to a merchant location are preferred to lineal or straight line measurements in determining the relevancy of the location of LAD 110 the merchant location, although the latter may be used without departing from the scope hereof. The actual distance of travel and rate of travel are used internal to system 100 for calculating ETA and/or RTT of LAD 110 to the merchant location. However, merchants typically care less about where the traveler is located than when the traveler might walk into his or her establishment, a distinction especially true for restaurants and lodging. For example, a traveler passing a motel location at 10 AM is less likely to stop. Thus, the merchant may not wish to participate in auctions for the motel at that time of day. Or, may offer other incentives relating to activities and events around the merchant location rather than an incentive relates to reducing the price of the room.

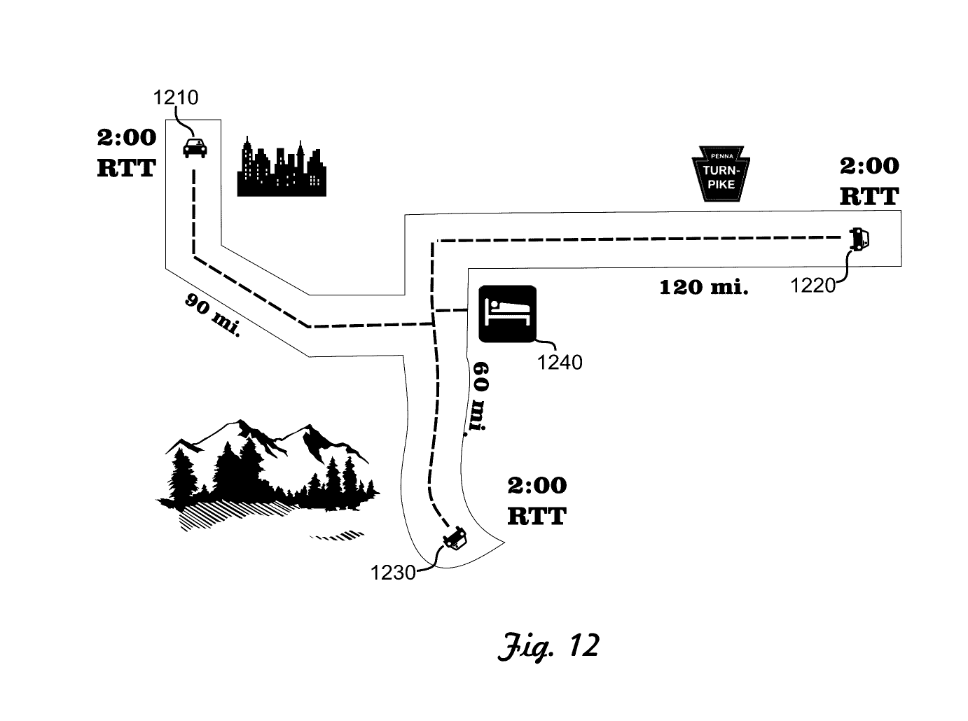

To illustrate the distinction between traditional methods of determining geographic relevance and RTT, ETA, or TOT FIG. 12 is a schematic comparing RTT and distance for three example LADs 1210, 1220, and 1230, each similar to LAD 110 of FIG. 1 and represented by an automobile icon. Each LAD 1210, 1220, and 1230 has a dramatically different distance to merchant 1040, but all have the same RTT. LAD 1210, driving through a city, is ninety miles from merchant location 1240. LAD 1230, driving through mountain passes, is only 60 miles from merchant location 1240, and LAD 1220, driving on the Pennsylvania Turnpike, is 120 miles away from merchant location 1240. Each LAD, however, has an RTT of two hours to merchant location 1240. Thus, distance alone is not useful to the merchant.

FIG. 13 is a schematic illustrating travel of LAD 110 towards a merchant location 1350 and a corresponding table 1360 illustrating calculation of RTT. LAD 110 (in this example illustrated by a car icon) is equipped with locator technology 130 and is moving along a known or hypothetical route 1340 over a mappable roadway 1320. LAD 110 sends positional coordinates (expressed as latitude and longitude in table 1330) to traveler alert server 140 at locations 1311-1318 as LAD 110 travels along route 1340. Table 1360 shows calculation of ETA and RTT in columns 1368 and 1369 respectively.

For location 1311-1318, LAT (Latitude) and LONG (Longitude) coordinates of table 1330 are provided to map data server 144. Merchant location 1350 is along or proximate to the projected or hypothetical route 1340. Map data server 144 stores comprehensive mapping data on relevant road networks as well as the locations of merchants along such networks, including merchant location 1350, primarily in the form of road vectors and attributes, nodes and geocodes. Map data server 144 may use third party mapping and navigational database such as provided by Navteq, Google, or TeleAtlas. Map data server 144 matches the location coordinates of the LAD 110 as it travels along route 1340 as expressed in columns 1330 and 1361 to the route nodes 1363 as each location coordinate is received from LAD 110. Each location received from the LAD 110 is time-stamped by ETA/RTT Resolver 143 as shown in column 1364. Where location coordinates of table 1330 do not precisely match the corresponding coordinates of route node 1363, the location may be extrapolated using a directional offset or a new route node may be automatically generated.

The ETA/RTT Resolver 143 then calculates the distance along the vector translated into miles, shown in column 1365, from each time-stamped nodes 1-7 (corresponding to received locations 1311-1317) to node 8 which represents merchant location 1350. Where the actual speed of the vehicle carrying LAD 110 is not initially known, ETA/RTT Resolver 143 may retrieve a posted route speed limit attribute from the route database, e.g., 65 miles per hour, shown in column 1366. ETA/RTT resolver 143 assumes this rate of travel to merchant location 1350 (node 8) and determines that the estimated time of arrival at node 8 is 6:00 PM, as shown in column 1368. Based on the stamped time of the route node shown in column 1364, ETA/RTT resolver 143 calculates that the time remaining to the merchant's location is one hour, shown in column 1369.

As the vehicle travels along route 1340 and locations and time stamps are received, the ETA/RTT Resolver 143 updates the ETA of column 1368 and RTT of column 1369 for LAD 110, assuming posted speeds between the time-stamped node and the destination node. However, as artisans of ordinary skill can appreciate, other factors may bear on actual or projected time of arrival, including stops at rest areas, detours, traffic congestion, accidents, construction and weather. When such additional factors are known, ETA/RTT Resolver 143 may adjust the average miles per hour in column 1367 between the last received time stamp and the destination node and use that speed in lieu of posted speeds to update ETA column 1368 and/or RTT column 1369. ETA and RTT as shown in columns 1368 and 1369 are used as further described herein.

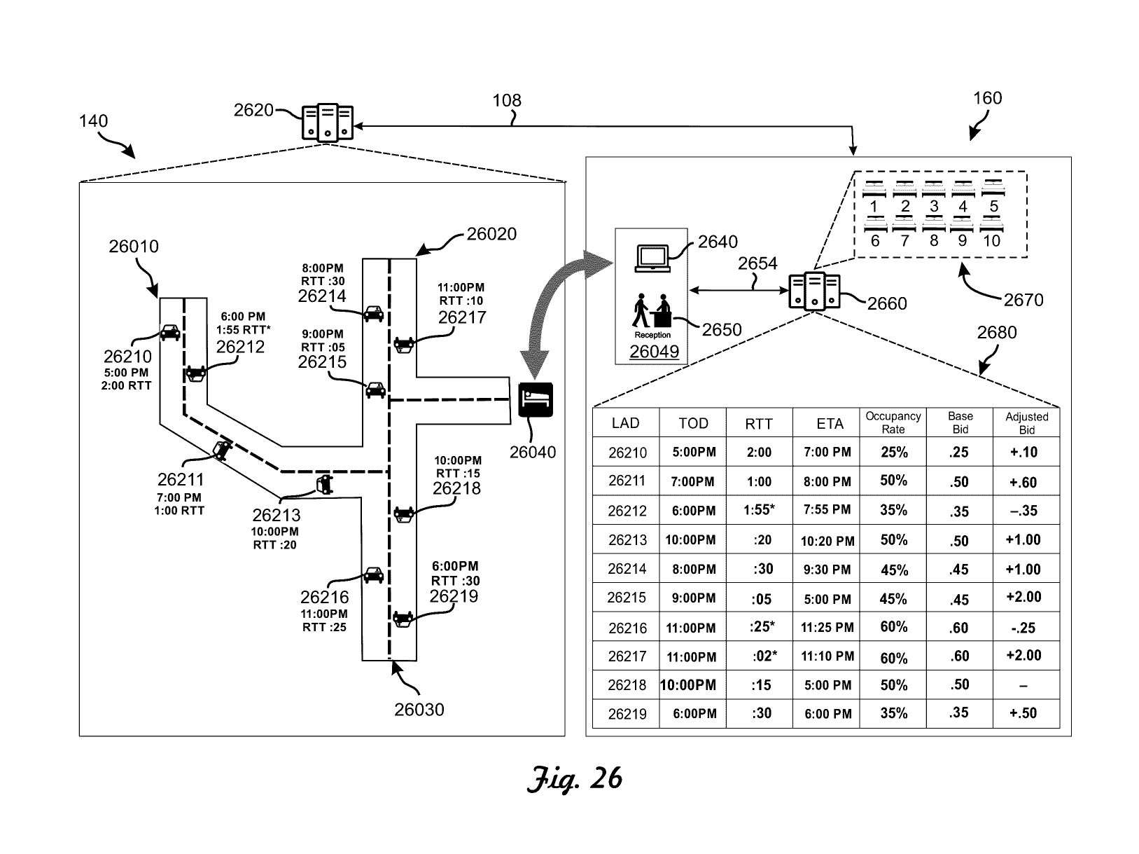

FIG. 14 is a table 1400 illustrating example location keywords that may be predefined within MBRS 160 of FIG. 1, or dynamically modified by programmatic business rules, for use with system 100 as described above and shown in FIG. 26. Location keywords may also be referred to as “routecentric” keywords herein. The selection of such keywords may be entered into MBRS 160 manually, e.g., through a website interface, or created programmatically according to business rules within MBRS 160 responsive to the merchant's business needs as further described at exemplary FIG. 26. The selection of and use of keyword bids are similar to the process employed by Google AdWords. Google AdWords is a well-known pay-per-click program where advertisers only pay when an on-line searcher clicks on a relevant advertisement that appears in response to search terms used by the searcher and upon which the advertiser has placed a bid. The price of the bid on one or more search terms, or keywords, determines where the advertisement appears on web pages in the search results. In the Google® model, the advertiser is charged for the bid only when an on-line user clicks on the advertiser's displayed advertisement. The preferred business model of the embodiments hereof is similar. If for example, Google® were to incorporate the Traveler Alert System into its AdWords program, the merchant/advertiser would only pay Google if, in response to one or more search terms processed by the traveler alert system, a traveler alert is transmitted to the LAD 110 and/or the traveler using LAD 110 clicks on a transmitted alert. However, other business models may be used as appropriate.

Table 1400 shows three example columns, “Search Category,” “Keyword” and “Bid” as used within MBRS 160 of FIG. 1. Table 1400 may be organized in a variety of configurations, applications and formats for use by MBRS 160 as a convenient way to select and bid on keywords. The search category column classifies keywords according to how they may be used elsewhere by system 100, such as illustrated in FIGS. 6 and 10. Location search categories in this example include Estimated Time of Arrival, Remaining Time of Travel, Distance from Merchant, Road Identification, Selected Road Segment, Direction Heading, Variation from Route (time), Variation from Route (distance), and Time of Day. Each classification thereby defines how the corresponding keyword(s) are to be used.

The Keyword column lists keywords that are matched to information generated from and about LAD 110 and/or the traveler using LAD 110. Relevant data may include, but is not be limited to, traveler preferences, traveler profiles, as well as dynamically generated data from the real-time travel activity of LAD 110.

Keywords may be expressed as one or more individual terms, or as a range of terms. For example, a restaurant may find that many dining tables are unoccupied from 8:00 PM to 9:00 PM but more tables are occupied from 6:00 PM to 7:00 PM. Thus the restaurant owner programs MBRS 160 to bid on motorists who are within fifteen minutes' travel of travel to the restaurant within each estimated time of arrival time frame, paying less ($0.50) for the earlier time slot of 6:00 PM to 7:00 PM, since fewer tables need to be filled and more ($1.00) for the later time slot of 8:00 PM and 9:00 PM when more tables need to be filled.

The example keywords as shown (e.g., time ranges, durations, distance ranges, road usages, segment usages, travel directions, and time of day, together with the remaining travel time to a destination and/or ETA as determined by ETA/RTT resolver 143 allow merchants a broad selection of keyword bids to target LAD 110's likely to be responsive to a merchant alert at a time relevant to the merchant, and to adjust both the cost, timing and content of such alerts tailor alerts based on the time of travel of the LAD 110 to the merchant along the relevant route.

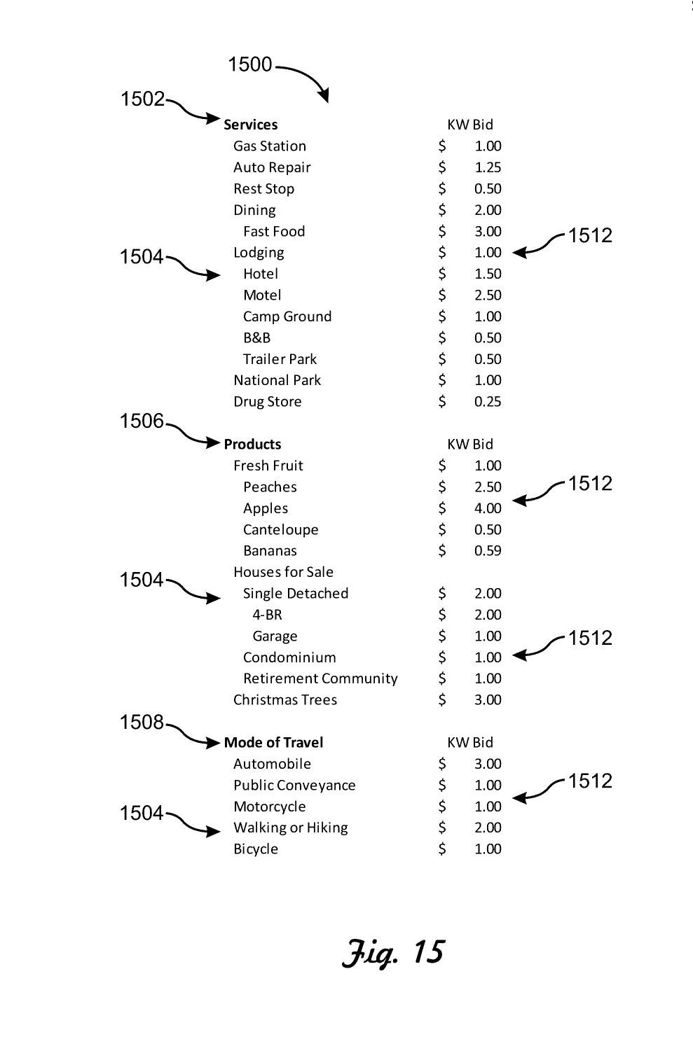

FIG. 15 shows a table 1500 that continues in a consolidated format from table 1400 of FIG. 14. Table 1500 illustrates example keyword categories 1502, 1506 and 1508 with associated example keywords 1504 and corresponding bid values 1512 within MBRS 160 of FIG. 1 for use with traveler alert server 140. As shown, keywords 1504 and categories 1502, 1506, and 1508 may be interchangeable depending on the requirements of system 100. Keywords 1504 and their corresponding bid values 1512 are directed to search terms generated from a number of different sources other than location, e.g., preferences inputted into LAD 110 by the traveler and transmitted to the traveler alert server 140, traveler profiles stored in LAD 110, traveler profiles 142, and/or updated from third party databases including the cloud, all of which may be prospectively responsive to keyword bids submitted by merchants manually or automatically from MBRS 160. Data responsive to a keyword bid, especially with respect to traveler profiles or prior traveler search histories, may be supplied by external advertising application 180 and/or third party applications, such as Google Now. Thus, any information from any source to which an advertiser/merchant keyword bid may be responsive may be incorporated into system 100 without departing from the scope hereof.

Mode of Travel keyword category 1508 lists keywords 1504 that form search terms used by merchant/advertisers to tailor alerts (e.g., alerts 124) to modes of travel. These modes of travel may be automatically detected by LAD 110 to indicate, for example, whether LAD 110 is in “Car Mode,” e.g., connected to an automobile's computer through Bluetooth, or may be manually set when the traveler has placed LAD 110 in “Airplane Mode.” Such auto-detection capability may be extended to any mode of travel and an enhancement to the multi-modal embodiment described at FIG. 19.

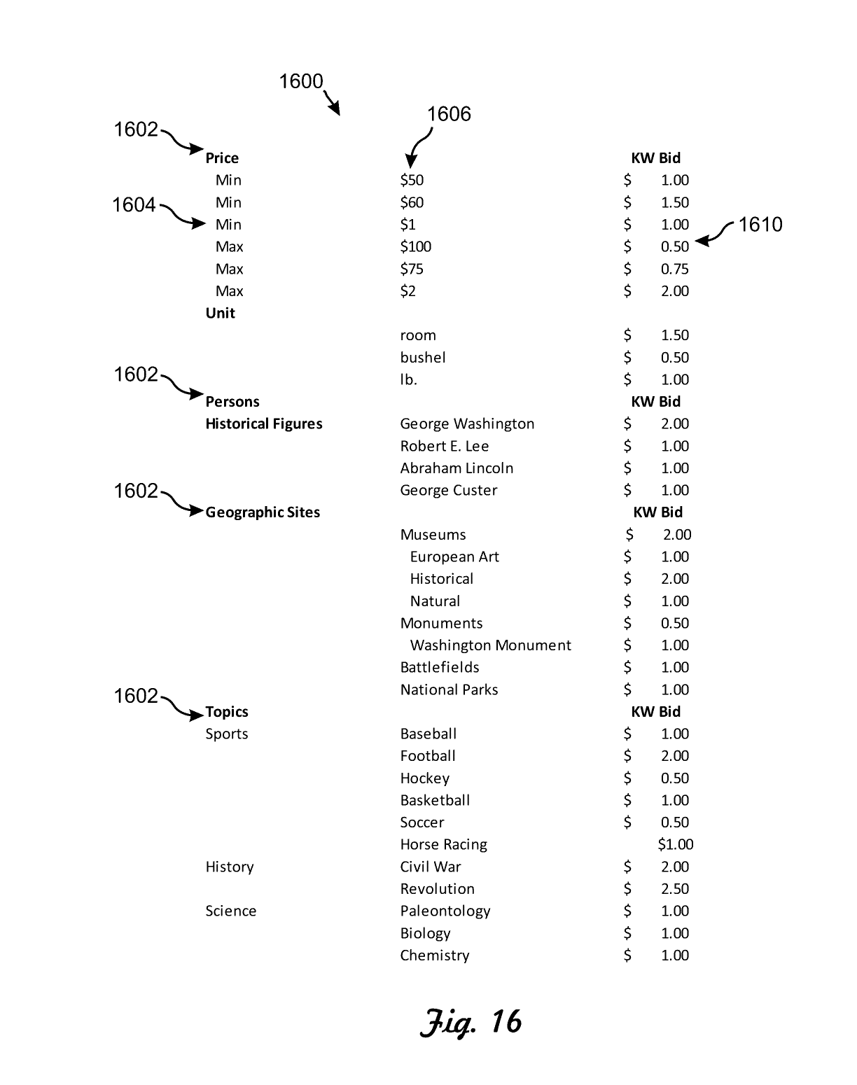

FIG. 16 is a table 1600 listing additional example keywords (alternatively “search terms”) 1606 organized by categories 1602, within ranges 1604 corresponding to a list of keyword bids 1610 placed by FIG. 1. Merchant Advertiser Business Rules Server 160 (MBRS). Keywords 1606 represent exemplary traveler preferences FIG. 1. 122a that may be entered by the traveler using LAD 110 (e.g., when implemented as smartphone 200 of FIGS. 2 and 3). The information displayed in table 1600 may be stored in any way suitable for convenient access, including but not limited to relational or associative databases responsive to structured or free-form queries.

FIG. 17 is a schematic illustrating operating of system 100 during example travels of a traveler using LAD 110 (e.g., a patent attorney) living in Alexandria, Va. within walking distance of the King Street Metro. The traveler has booked a flight departing from Reagan National Airport, arriving at San Francisco International Airport. He remains undecided about whether to take a taxi or rent a car to get to his ultimate destination, the Holiday Inn San Francisco—Fisherman's Wharf sometime that evening. He has made no dinner plans. Two merchants, a rental car agency at the San Francisco airport and a restaurant proximate to the hotel use traveler alert system 100 to offer services to such travelers based on their remaining time of travel to each corresponding establishment.

ETA/RTT Resolver 143 receives location information from LAD 110 and determines RTT of LAD 110 to merchant locations (e.g., merchant location 162) based upon the multimodal route of the traveler. Alert generator 148 sends alerts (e.g., alerts 124) from various vendors along the route to LAD 110 based upon rules defined within MBRS 160. In this example, the origin and destination of the route are known, but neither is required and either may be hypothesized.

In this example, Lad 110 is implemented within a smartphone that is carried by the traveler. Operation of LAD 110 may be enhanced by an operating system and other applications running on the smartphone that cooperate to aggregate traveler information from various sources, such as Google Now. Such information may allow traveler alert server 140 to define the traveler's estimated time of travel for the multiple modes of travel and thereby track the traveler's location in real time and generate alerts 124 using auction server 147, automatically adjusting the generated alerts as the traveler's itinerary is realized in real-time.

Traveler alert server 140 first determines RTT 1702 and 1740 from an origin 1741 to merchant destinations 1780 and 1719 based on information directly or indirectly supplied through one or more of traveler preferences 122a, traveler profiles 142, and data stored on the LAD 110. For example, system 100 may draw from a stored e-mail confirming a reservation at the destination or a receipt for airline ticket purchases. In one example, the traveler enters an origin and destination at or before the time of departure from origin 1741. In this example, traveler alert server 140 identifies the address “1220 Prince Street, Alexandria, Va.” as the traveler's origin and the Holiday Inn at 1300 Columbus Ave, San Francisco, Calif. as the traveler's destination. Where server 140 does not have sufficient information about an itinerary, such as a missing destination, server 140 may build and modify hypothetical routes, origins and destinations based upon information received from, and progress of LAD 110 (i.e., actual travel of the traveler) such that the traveler's intermediary destinations (e.g., the airport) become known.

Traveler alert server 140 assembles a preliminary and prospective multimodal travel path from this information based upon any known information such as origin and final destination. In the example of FIG. 17, the origin and destination are known. Server 140 determines an initial route based upon certain assumptions and default modes of travel, all of which may be modified as travel information is received in real time. Server 140 may also base the initial assumptions on the fastest mode of travel or historical information that indicates the traveler's use of certain services, such as the subway and taxi services. Server 140 may also make assumptions based upon distance to an assumed destination. For example, server 140 may determine that the traveler will most likely walk to the King Street Metro, take the King Street Metro (rather than a taxi) for either the Blue or Yellow line to Reagan National Airport, ride a moving conveyor escalator to the check-in, fly to San Francisco International Airport, ride the escalator to ground transportation to pick up a rental car, and then drives to the final destination.

In the example calculation, the traveler using LAD 110 leaves home on Prince Street, loading traveler alert system 100 software application on a location aware device (e.g., a smartphone) to form LAD 110, granting permission for LAD 110 to track the traveler's location and to access information stored on the smartphone, including, for example, a calendar, e-mail, room reservation, flight information, on-line Facebook, Linked-In, other application profiles, and other information that may be available through third-parties aggregation services, such as Google Now. Server 140 then initially calculates, based upon a current location of LAD 110 and the known or hypothetical route of LAD 110 as described above, RTT values for each of two example merchant locations, a rental car agency 1780 and a restaurant 1790, wherein the RTT 1740 from the origin 1741 to the rental car agency 1780 is eight hours and twenty minutes and the RTT 1702 to the restaurant 1790 is nine hours and fifteen minutes.

LAD 110 may include an accelerometer that may be used to detect when the traveler begins walking from origin 1741 at a start time 1730 (e.g., 10:00 Eastern Daylight Time (EDT)). The traveler continues on foot in a westerly direction on Prince Street. With information supplied by the accelerometer and location data 132 provided by locator technology 130, LAD 110 and/or server 140 determines that the traveler will take fifteen minutes to reach the King Street Metro station, generating RTTs 1742 and 1704 to merchant locations 1780 and 1790, respectively. Importantly, the location, type of technology, and location data accessed by the location-based technology may bear on how server 140 determines which mode of travel to apply to its ongoing route calculations. For example, rather than walking to the metro station and taking the metro to the airport, the traveler may elect to take a taxi to the airport. Or the traveler may elect to drive his private vehicle and park it in the airport garage. Server 140 may acquire such information from one or more of the traveler's location-aware device, location-aware technology incorporated in the relevant mode of transportation, location-aware technology along the route, and from an external data network. Travel conditions also may be detected automatically by LAD 110 through the use of integrated sensors. For example, LAD 110 may detect and track travel characteristics in real time. For example, LAD 110 may use an accelerometer to determine when the airplane takes off, or when the traveler is sitting in an airport lounge. Such technology may be used to supplement other location-based technology to allow server 140 to more accurately track the progress of the traveler.

In one example of operation, server 140 determines (e.g., accessing information in the cloud) that the average wait time for the Metro at the current time of day is five minutes and that the trip to Reagan National Airport takes an average of ten minutes. Server 140 may then update the RTT to each merchant location 1780 and 1790, shown as RTTs 1708 and 1748, respectively. Server 140 may then access flight information (e.g., using information stored on the traveler's smartphone or accessed via the cloud) to determine an estimated time of departure from the airport. Server 140 may then determine RTTs 1760 and 1710, to merchant locations 1780 and 1790, respectively, using flight data from Flight Aware or other suitable flight monitoring service. Thus, server 140 utilizes information that is updated dynamically, such as to incorporate delays caused by weather for example. If the traveler' flight information is not available, server 140 may select a flight departure that closely approximates the traveler's actual time of arrival at the airport. In either case, server 140 applies a predetermined check-in and boarding delay, to update the RTTs to merchant locations 1780 and 1790, as indicated by RTT 1708 and 1748, respectively. In the example of FIG. 17, the average time of travel for the flight is five hours and thirty minutes, touching down 1734 at three-fifteen PM Pacific Daylight. Accordingly, server 140 updates RTTs 1712 and 1762 for merchant locations 1780 and 1790, respectively.

The traveler spends thirty-five minutes retrieving luggage, and server 140 determines am RTT 1714 of one hour and twenty-five minutes to merchant location 1790 (the restaurant) and an RTT 1764 of thirty minutes to merchant location 1780 (the rental car agency).

Independently, CodMother Fish and Chips, corresponding to merchant location 1790, is located on Fisherman's Wharf three minutes walking distance from the Holiday-Inn Fisherman's Wharf, the traveler's final destination. CodMother Fish and Chips places multi-modal keyword bids intended to capture the origin and destination of any known or hypothetical single or multi-modal route of any traveler whose initial remaining time of travel from the traveler's origin is ten hours or less and whose destination falls within an RTT of ten minutes walking time to the restaurant.

The exemplary itinerary of the traveler described above falls within the parameters of the CodMother Fish and Chips' bids, resulting in the transmission of alert 1784 to LAD 110 as the traveler leaves home (i.e., origin 1741) at 10:00 EDT and a second alert 1782 transmitted upon the traveler reaching the Holiday Inn.

Concurrently, a Hertz rental car facility at the San Francisco International Airport corresponding to merchant location 1780, programs its MBRS 160 with rules that control how and when traveler alert server 140 transmits alerts 1781 (e.g., advertising alerts 124a and auction alerts 124b) to travelers landing at San Francisco International Airport. In the example of FIG. 17, MBRS 160 is configured to schedule alerts 1680 to be transmitted to LADs 110 of any traveler boarding a flight with a remaining time of travel to the rental facility of five hours or more. Thus, server 140 transmits travelers alerts 1781 as the traveler using LAD 110 boards the flight with RTT 1760 of six-hours and thirty-five minutes and again when the traveler lands with an RTT 1762 of one hour and five minutes.

FIG. 18 is a schematic illustrating a map 1800 of a map 1800 generated by FIG. 1 Map Data Server 144, table 1840 and table 1850 illustrating how remaining time of travel (RTT) keywords as employed by FIG. 1 ETA/RTT Resolver 143 and Auction Server 147 operate to exclude (or conversely include) merchant locations along hypothetical routes from a secondary priced auction. Map 1800 displays LAD 110 within a vehicle, roadway 1807 and travel route 1830 known to point 1812, which could be an intersection. At the intersection, LAD 110 can turn left or right to travel along hypothetical travel routes indicated by dashed line 1860 and marked individually as A, B, C, D, E, F, G and H. Map 1800 also identifies merchant locations 18210, 18212, 18213, 18214, 18215, 18216, 18217, and 18218 along these hypotheticals routes. Table 1840 displays merchant locations in column 1842, and route codes in column 1843 corresponding to the map display 1800 and correlates these columns to calculated RTT values in column 1844, RTT keywords in column 1845 and bids values in column 1846.

ETA/RTT resolver 143 uses location information received from LAD 110 to calculate RTT values of column 1844 for LAD 110 to reach each merchant location 18210, 18212, 18213, 18214, 18215, 18216, 18217, and 18218 from a location 1812. Auction server 147 then compares the calculated RTT values of column 1844 to RTT keywords of column 1854, supplied by MBRS 160 for each merchant corresponding to merchant locations 18210, 18212, 18213, 18214, 18215, 18216, 18217, and 18218 for example, and enters corresponding bid values of column 1846 in the GSP auction 1870 to generate table 1850. The bids may be received randomly within system 100 but shown in numerical order in Table 1840 to more clearly illustrate the effect of the GSP auction 1870 in results table 1850.

Merchant locations 18215, 18217 and 18213 do not fall within the determined RTT column 1844 of LAD 110 and are shown deleted on map 1800 and in table 1840. Auction server 147 uses GSP auction 1870 to rank remaining bids as shown in table 1850.

The eligibility of each merchant to participate in an auction dynamically changes according to the RTT of LAD 110 to each merchant location, and based upon changes to keywords dependent upon the current location of LAD 110.

As used in the embodiments of system 100, geometric shapes such as a radius, circle, partial circle, sector polygon, and their corollary keywords applied in a manner consistent with well-established electronic mapping techniques known to artisans of ordinary skill may be used to (1) limit the transmission of traveler advertising alerts 124a by system 100 to LAD 110 when it is located within/without the proscribed geographic geometry; (2) restrict the number of hypothetical paths when a calculation of hypothetical paths is required; (3) reduce the number of eligible merchants that, based on their location, may participate in one or more auctions, typically in response to a preference received by traveler alert server 140 and (4) prioritize merchant bids that match traveler preferences received from LAD 110 and/or supplied from MBRS 160. While the example geometric shapes described and shown in the various figures are preferred, other ways of overlaying map boundaries may be used, such as freehand, 2-point line, Bezier, b-spline, polyline, and 3-point curves that may more accurately depict the perimeter of a geographic region, for example.

FIG. 19 is a schematic showing a map 1900 and corresponding tables 1960, 1970 and 1980, to illustrate use of a geometric shape defined by a radius to exclude (or conversely to include) one or more merchant locations 19210, 19212, 19214, 19215, 19216, 19217, and 19218 in an auction by auction server 147 of FIG. 1. Table 1960 correlates RTT of LAD 110 to keywords/bids received from MBRS 160. Radius keyword table 1970, and a radius keyword followed by RTT preference keyword table 1960, that together illustrate example operation of alert system 100 of FIG. 1.

As shown in map 1900, seven merchants 19210, 19212, 19214, 19215, 19216, 19217, and 19218 are located on hypothetical routes A-H of LAD 110 traveling a known route 1908 along a roadway 1930 to a location 1912. Hypothetically routes A-H are located along roadways 1950 and 1959. Location 1912 is a reference point that alternatively may be one of an intersection, exit, the geographic position of the LAD 110 on the route, or an arbitrary point. Map data server 144 positions radius (circle) 1980 from location 1912, which may be defined by off-route search preference entered by the traveler using LAD 110, by system default, by a system administrator, and/or by merchant advertiser business rule, wherein the perimeter intersects hypothetical routes, e.g., roadways (e.g., streets and sidewalks) 1930, 1940, 1950 and 1960 identified on map 1900.

Using the map information from map data server 144, ETA/RTT resolver 143 calculates 1955 RTTs, as shown in table 1960, for LAD 110 to reach each merchant location 19210, 19212, 19213, 19214, 19216, 19217, and 19217 along roadways 1930, 1940, 1950 and 1959, over hypothetical routes individually identified as routes A-H. However, results for merchant location 19218 are excluded since that location is outside radius 1979.

Auction server 147 of FIG. 1 then conducts a secondary price auction 1965 of radius keyword bids, ordering results as shown in table 1970. Since, in the example of FIG. 19, a radius keyword preference has been received from LAD 110, auction server 147 conducts (a) a follow-up secondary price auction incorporating the keyword preference and remaining eligible keyword bids as shown in table 1980; (b) a reverse auction in lieu of the follow-up secondary price auction, or (c) it may bypass all secondary price auctions and conduct a reverse auction only for merchants whose preference keyword bid matches the keyword preference.

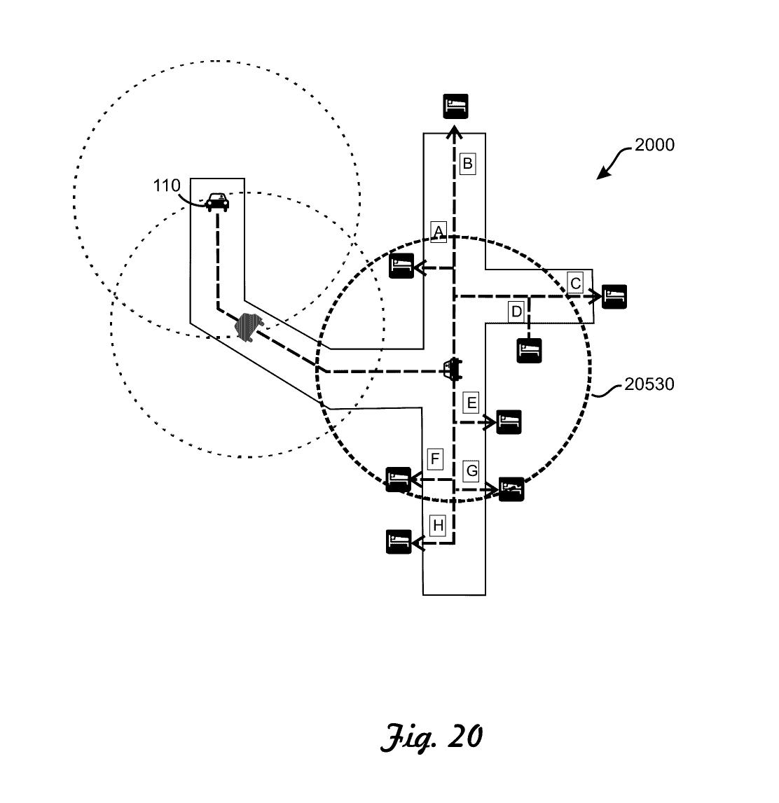

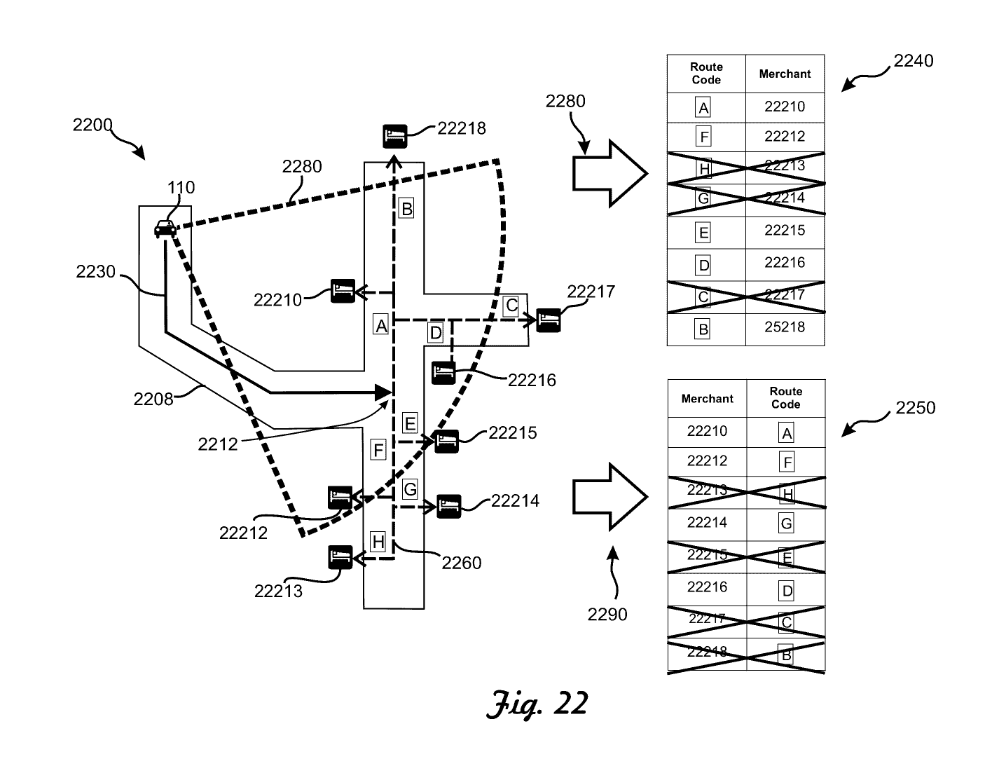

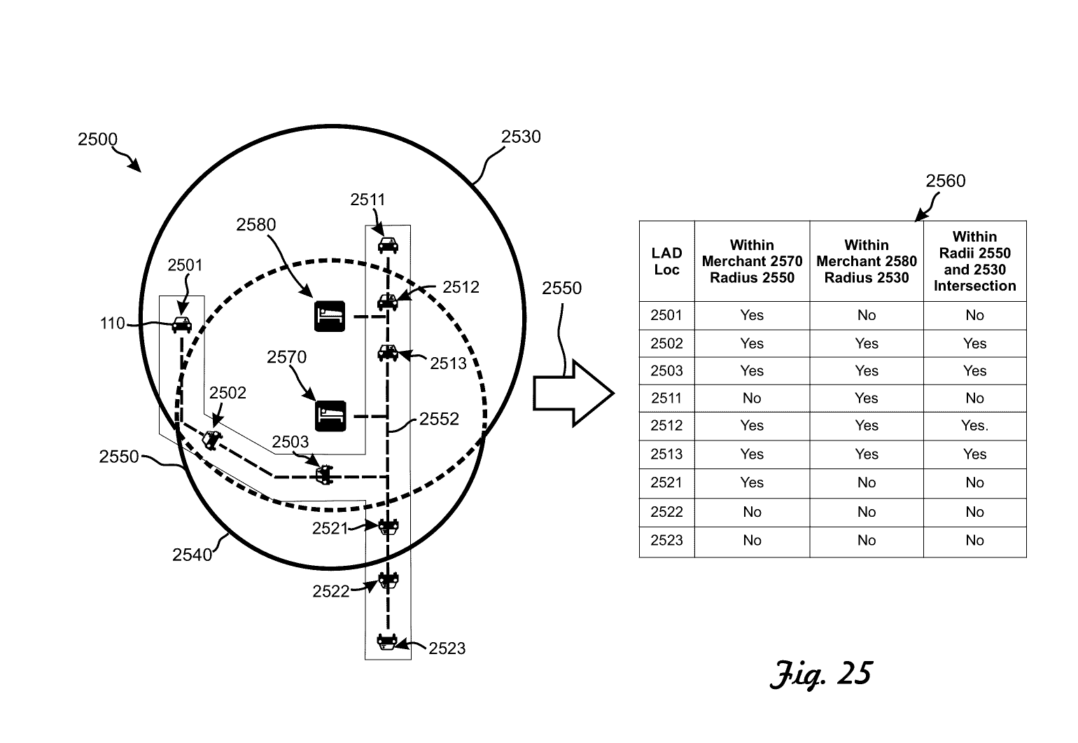

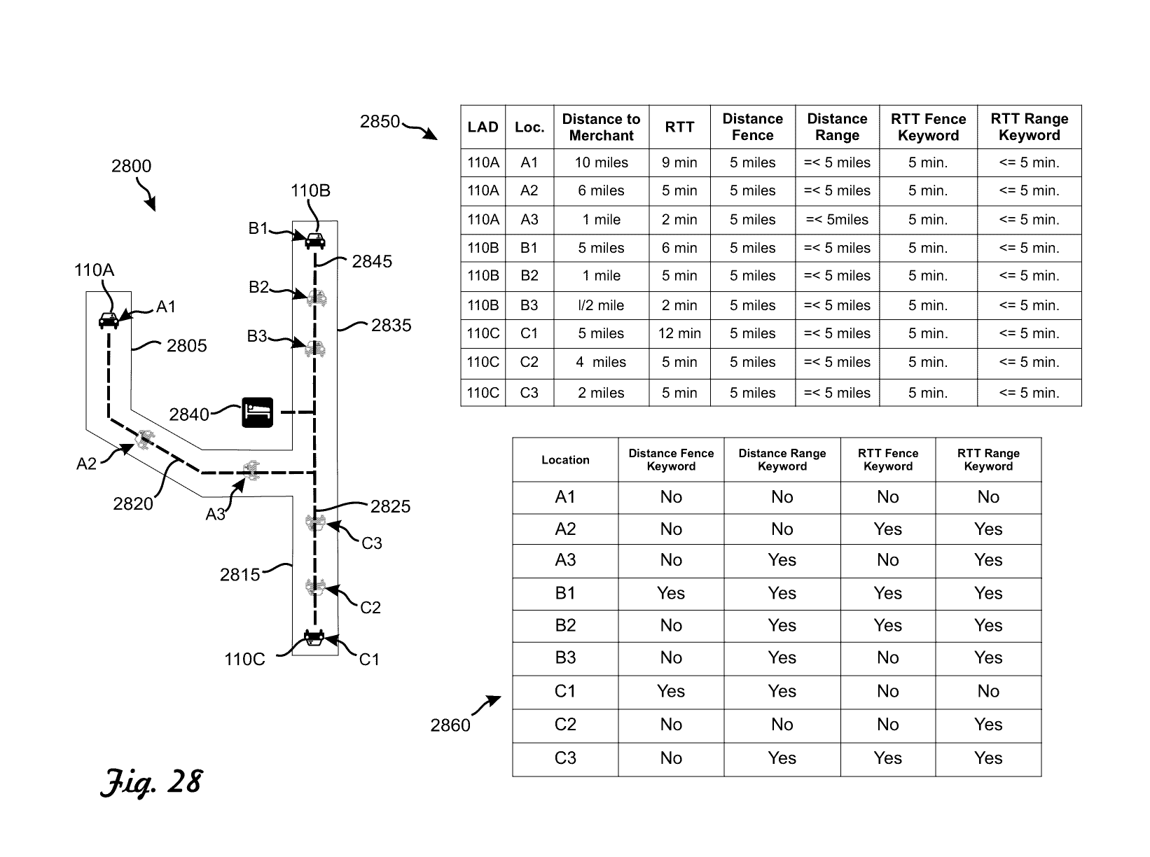

Radii center points may include but are not limited to: beacons, cell towers, road segments, mile markers, points of interest, destinations, the location of the LAD 110 or the location of the merchants displayed and described in FIG. 22, FIG. 25 and FIG. 27, FIG. 28, and FIG. 30. respectively. Alternatively, polygons or sectors may be used as shown in FIGS. 20, 21 and 23.

FIG. 20 shows a map 2000, similar to map 1900 of FIG. 19, illustrating use of an example radius 20530 having its center defined relative to LAD 110 and used to include or exclude merchant locations based upon their distance relative to the current location of LAD 110. As LAD 110 changes location, the location of radius 20530 moves with LAD 110. In all other respects, the radius operates to exclude (or conversely) include merchant locations as described in FIG. 19.

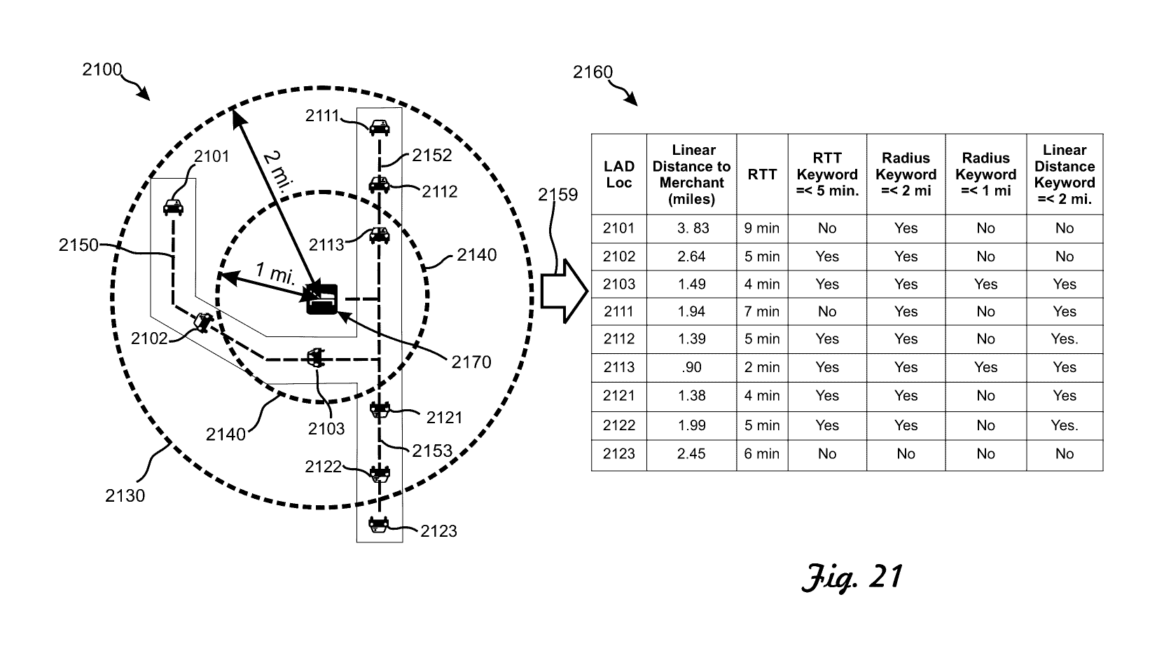

FIG. 21 illustrates two example radii 2130, 2140 whose center points are merchant location 2170 that when selected as a keyword operate to include or exclude LAD 110s from receiving traveler alerts at the time of an auction as shown in Table 2160 While radius searches to determine nearby locations are well known in the prior art, in this embodiment the precise locations of LAD 110s defined by the radius is less important that whether the LAD 110 is within the geographic vicinity defined by the radius and therefore responsive to an equivalent radius keyword.

Specifically, FIG. 21 shows map 2100 and an associated table 2160. Map 2100, generated by map data server 144, FIG. 1, displays locations 2101, 2102, 2103 2111, 2112, 2113, 2121, 2122, and 2123 on routes 2150, 2151, and 2152, respectively, of nine different LADs (e.g., LAD 110). From information stored in MLSL 146, map data server 144 generates map 2100 with merchant location 2170. In response to rules defined within MBRS 160, map data server 144 determines a radius of one mile around merchant location 2170, illustratively displayed as a circle, and a second radius of 2 miles around merchant location 2170, illustratively displayed as a circle, such that merchant location 2170 is the center point of each radius. Map data server 144 identifies each LAD 110 within the respective radii, determines the linear distance of each location 2101, 2102, 2103 2111, 2112, 2113, 2121, 2122, and 2123 to merchant location 2170, passing that information (depicted by arrow 2159) to ETA/RTT resolver 143, which in turn calculates the remaining time of travel for each identified LAD 110 to merchant location 2170 as shown in columns one and two of table 2160. Location, calculated speed of travel, and RTT are updated in real time as the information is received from locator technology 130 of each LAD 110.

The remaining four columns of table 2160 show example keywords that affect receipt of traveler alerts by LADs 110 from the merchant based on the defined radii. For example, if at the time of an auction the merchant has selected a keyword radius of equal to or less than two miles, LAD 110 at location 2123 does not receive an alert (assuming no other keyword are selected). Nothing precludes the merchant defining additional rules within MBRS 160 to allow bidding on other routecentric keywords according to business models illustrated in FIG. 25.

FIG. 22 shows a map 2200, and a geographic vicinity defined as a circle sector 2280 that has a center point is at a current location of LAD 110, and a corresponding table 2240. FIG. 22 illustrates example operation of system 100 to exclude hypothetical routes and/or merchant locations from either a GSP auction or a reverse auction as shown in FIG. 18. While excluding a hypothetical route necessarily excludes merchants located along such route, excluding a merchant does not necessarily exclude a hypothetical route, but may exclude only a portion of it. Since either operation may influence merchant bit entry in subsequent auctions, both operations are shown in this example.

Map 2200 shows seven example merchant locations 22210, 22212, 22213, 22214, 22215, 22216, and 22217 and a current location of LAD 110 that intends to travel route 2230 to reference location 2212, at which point LAD 110 may take one of hypothetical routes A-H.

Map data server 144 defines a circle sector 2280 having a center point at the current location of LAD 110. The central angle and projection distance (and thus arc length) may be set as traveler preference, system default, or dynamically influenced by the direction and speed of the LAD 110. Circle sector 2280 effectively “scans” routes to be prospectively traveled by LAD 110.

In this example, circle sector 2280 applied by map data server 144 surrounds and includes hypothetical routes A, B, D, E, F and excludes hypothetical routes C, G and H as shown in table 2240, generated by ETA/RTT resolver 143 and auction server 147 as shown in FIG. 19. Alternatively, circle sector 2280 excludes merchant locations 22218, 22218, 22215, 22214, and 22213 at 2290 as shown in table 2250.

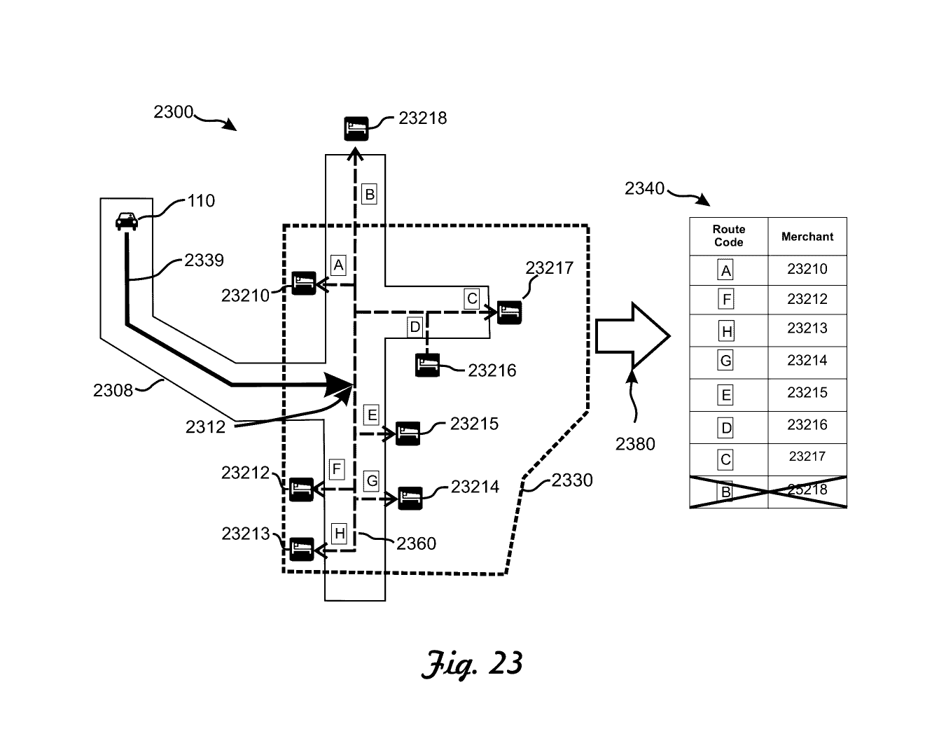

FIG. 23 shows a map 2300 and a corresponding table 2340 illustrating an example geographic vicinity defined as a polygon 2330. In the example of FIG. 23, polygon 2330 excludes, or conversely includes, bids (defined by rules of MBRS 160) for hypothetical routes in either a secondary priced auction or a reverse auction as described in FIG. 19.

Map 2300 shows seven example merchant locations 23210, 23212, 23213, 23214, 23216, and 23217. Travel route 2339 to reference location 2312 of LAD 110 is known, after which LAD 110 may take one of hypothetical routes A-H.

Map data server 144 defines polygon 2330 with respect to map 2300. Polygon 2330 may be drawn and adjusted by the traveler using LAD 110 according to electronic mapping techniques and principles well known to artisans of ordinary skill. For example, if the mode of transport associated with LAD 110 was pedestrian, boundaries of polygon 2330 may be defined to follow streets. Alternatively, polygon may include or approximate curves that trace map contours or other map features, such as streams.

In the example of FIG. 23, polygon 2330 surrounds and includes hypothetical routes A, C, D, E, F, G, and H but does not include hypothetical route B. ETA/RTT resolver 143 and auction server 147 may use this information to exclude hypothetical route B from further processing. Any merchant locations along hypothetical route B, which in this example is merchant location 23218, are also excluded from further processing. The remaining eligible merchants are then processed as shown in FIG. 19.

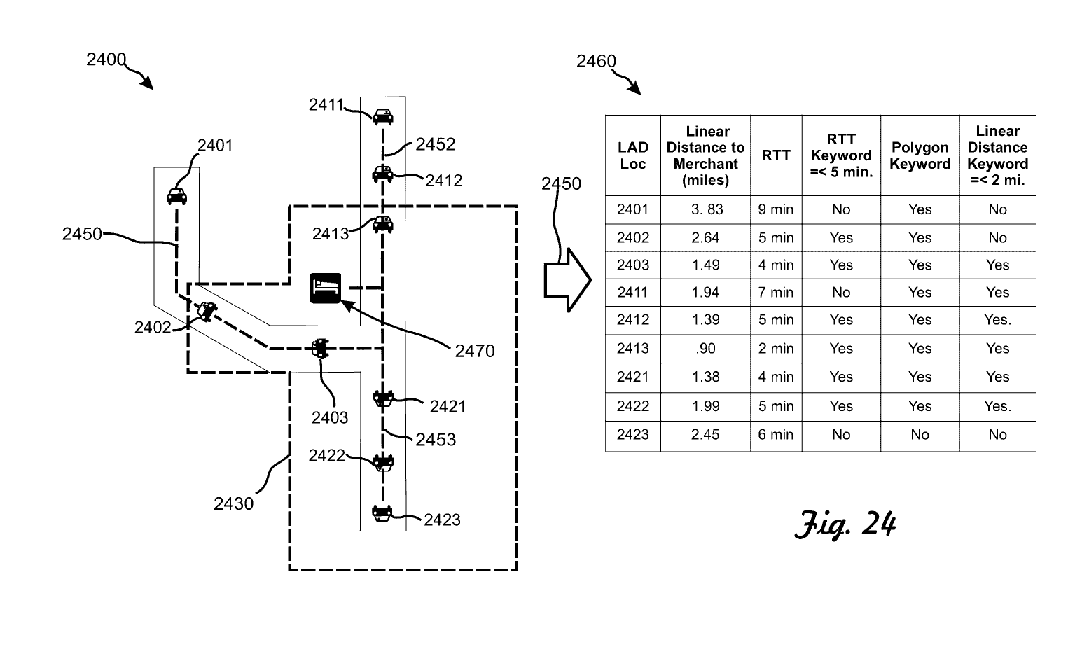

FIG. 24 shows a map 2400 that is overlaid by one example polygon 2430 defined within a rule of MBRS 160 by a merchant to defines a geographic vicinity for selecting one or more LAD 110 at locations 2401, 2402, 2403, 2411, 2412, 2413, 2421, 2422, and 2423, relative to a merchant location 2470. Use of polygon 2430 by system 100 is similar the use of the radius described in FIG. 21. The merchant may derive the shape of polygon 2430 from any number of underlying references, including but not limited to streets, sidewalks, intersections, mapped geographic regions, zip codes and the like and may be automatically generated from map data. In this example, polygon 2430 is deployed based upon rules defined within MBRS 160.

FIG. 25 shows a map 2500 illustrating the intersection of two radii 2530 and 2550 (dotted line) corresponding to merchant locations 2580 and 2570, respectively, that operate to determine the eligible locations 2502, 2503, 2512, and 2513 of LAD 110 to receive traveler alerts from corresponding merchants based upon a GSP auction and/or a reverse auction as described above.

Where a geographic vicinity (e.g., a radius) is defined within a rule of MBRS 160 for a particular merchant location, the corresponding merchant bids to participate in an ensuing auction to promote their bid over another bids from other merchants, particularly where geographic vicinities of other merchants overlap within the merchant's geographic vicinity. For example, two merchant locations are directly across from one another on a well-traveled vacation route, and each merchant sets their respective MBR rule to a one-mile radius. The two circles overlap along a significant portion of the route. When a current location of LAD 110 is within the overlapping geographic vicinity, the merchant competes with the other merchants to send alerts to LAD 110. The resulting bids from each merchant determines which alert is received first by the user (e.g., a passing motorist) of LAD 110. For example, a minimum bid would be required given the general enhancement afforded by a geographically related keyword, even if no additional bidders were involved with a prospective auction and overlap were to occur.

More specifically, map data server 144, receives location data from ten different LADs 110 (e.g., using locator technology 130 and/or external location data 132 for each LAD) and determines LAD locations 2501, 2502, 2503, 2511, 2512, 2513, 2521, 2513, 2521, 2522, and 2512 along known or hypothetical routes (indicated by dashed line 2552). From information stored in MLSL 146, map data server 144 generates map 2500 with merchant locations 2570 and 2580. Within MBRS 160, each merchant location 2570, 2580, has a defined radius keyword, e.g., one mile, that is applied by map data server 144 to circumscribe a geographic vicinity surrounding the merchant location as the center point of the radius. Each radius 2530, 2540, is used to identify specific LADs 110 located within the respective radii, as a potential recipient of a merchant alert from the corresponding merchant. As shown in table 2560, radius 2550 defined by the merchant corresponding to merchant location 2570, identifies LADs 110 at locations 2501, 2502, 2503, 2512, 2513 and 2521. Radius 2530 as defined by the merchant corresponding to merchant location 2580, identifies LADs 110 at locations 2502, 2503, 2511, 2512, and 2513. Neither radius includes LAD locations 2522 and/or 2523.

In the example of FIG. 25, LAD location 2521 is captured by radius 2540 and is not captured by radius 2530. Accordingly, travel alerts 124 from the merchant associated with merchant location 2570 are prioritized by auction server 147 over all other keywords received from any other merchant irrespective of the amount of merchant bids on those keywords.

In another example of FIG. 25, LAD locations 2502, 2503, 2512, and 2513 are identified within both radii 2530 and 2540, wherein auction server 147 prioritized the resulting traveler alerts based upon the highest bid submitted by one of the merchants associated with merchant locations 2570 and 2580.

FIG. 26 shows exemplary adjustments to merchant bids, in a table 2680, by MBRS 160 of traveler alert system 100, FIG. 1 in response to three example routecentric keywords “time of day (TOD),” “remaining time of travel (RTT)” and “estimated time of arrival (ETA),” received from traveler alert server 140. In the example of FIG. 26, traveler alert server 140 collects mapping information 2610, which includes (a) location and time at location for ten different LADs 110 at locations 26210-26219, such as when traveling along roadways 26010, 26020 and 26030 in various directions (e.g., as indicated by the orientation of the icons); (b) merchant location 26040; and (c) RTT for each LAD location 26210-26219 to merchant location 26040. As shown, RTTs to merchant location 26040 of LADs 110 at locations 26212, 26216, and 26217 are increasing (indicated by an asterisked). Traveler alert server 140 transmits information 2610 via communications link 108 to MBRS 160, which determines the bids of the merchant corresponding to merchant location 26040 for use within traveler alert server 140, such as in one or both of a GSP auction and reverse auction.

Importantly, the LADs 110 at locations 26210-26219 represent any LAD 110 that system 100 determines to match the keywords display in table 2680.

MBRS 160 is shown with a system interface 26049, such as a point-of-sale computer 2640 or the like on a reception desk 2650 of a motel at merchant location 26042 that corresponds to merchant location 26040 and has been identified within information 2610. Point-of-sale computer 2640 is shown networked with a motel management system server (MMS) 2660.

MMS 2660 tracks business variables that effect the profitability of a motel at merchant location 26040, such as occupancy rate 2670, for example. Variables may include any reasonable parameter affecting the performance of the business, including the cost and return associated with the merchant's participation in system 100 itself, including but not limited to keywords, keyword bids, relevant click through rate (CTR), and conversions of CTR to paid customers.

Using information supplied by MMS 2660 MBRS 160 may also rely on predetermined but adjustable business rules to place bids on a wide range of possible keywords at the time of an auction to reflect the location and direction of LAD 110s, displayed in table 2680. Column headers of table 2680 are, LAD=Location Aware Device, TOD=Time of Day, RTT=Remaining Time of Travel, ETA=Estimated Time of Arrival, Occupancy Rate, Base Bid, and Adjusted Bid.

In one example of operation, MMS 2660 calculates a base bid of 0.35 cents for any LAD 110 that, at 6:00 PM, has an RTT to merchant location 26040 of one hour and fifty-five minutes (i.e., an ETA of 7:55 PM) and when occupancy rate at the time of the auction is 35%. MMS 2660 has previously determined however, a range of keyword variables and keyword ranges reflect the possibility that a traveler is headed away from, rather than toward, the merchant location. In the example of FIG. 26, the traveler at LAD location 26212 is both a one hour and fifty-five minute RTT and headed away from merchant location 26040. As shown in Table 2680, the traveler at LAD location 26212 results in a predetermined bid of −0.35 cents, in effect negating the 0.35 bid which otherwise would have been placed had the vehicle been headed toward the merchant location 26040.

In contrast, LAD 110 corresponding to LAD location 26217 is also heading away from the merchant, but the circumstances are quite different. In this case, the time is 11:00 PM, the occupancy rate of the motel is 60%, and the estimated time of travel to the motel of LAD 110 from location 26217 is only two minutes if the traveler using the LAD could be encouraged to turn around. Each of these are possible keywords. Hence, MMS 2660 has been programmed to bid $2.00 on any LAD 110 where the time of day, occupancy rate, direction, and the estimated time of travel of the LAD matches the keyword parameters.

Other bids are similarly adjusted. As shown in FIGS. 10 and 11, by way of example, content of alerts 124 is also automatically adjusted based on these or similar factors.

FIG. 27 shows an example of traffic flow analysis by MBRS 160 of FIG. 1, to and adjust keyword bids for LADs whose locations are known, but whose prospective paths of travel are not. MBRS 160 determines the value of a bid based on a probability that LAD 110 will approach, pass near, or pass by, a particular merchant location.

In this example, map 2700 depicts LAD 110 (e.g., a motorist) entering roadway 2705 (e.g., either the east or west entrance of the Pennsylvania Turnpike), a hypothetical travel path 2730, an exit 2712 (e.g., the Breezewood exit), hypothetical paths A-H past exit 2712 and along roadways 2706, 2707, and 2708, and merchant locations 27210, 27212, 27213, 27214, 27215, 27216, 27217, and 27218.

Data of the Pennsylvania Turnpike's traffic volume and flow have been downloaded and entered into a database of MBRS 160. The Turnpike administration reports that over the course of one year 156 million vehicles travel the turnpike. From this and other data, MBRS 160 constructs a table 2740, tabulating probability of a certain vehicle entering and exiting the Turnpike (see column “West Tpk Ent”) and/or traveling in various directions thereafter (see column “From Exit 2712”). MBRS 160 processes information of table 2740 to generate a table 2760, converting these probabilities into vehicle numbers. For example, MBRS 160, corresponding to merchant location 27210, estimates that 4,680,000 vehicles entering the Pennsylvania Turnpike at its most western entrance will pass by merchant location 27210 during the course of a year.

This data may influence keyword bids as well as the design of traveler alert campaigns in numerous ways. For example, a merchant may create a campaign to only target motorists headed east towards Breezewood at a time of day where their remaining times of travel (RTT) best correlate to the merchant's business model. MBRS 160 may then apply the statistical probability of the motorist passing past the merchant location to the cost of the bid as shown in FIG. 26. MBRS 160 may be programmed to download such information automatically and update campaigns and bids dynamically based on traffic flow at any given hour or minute.

FIG. 28 shows how three example routecentric keywords may affect the eligibility of one or more LADs 110 of FIG. 1 to receive traveler alerts 124, distinguishing keywords based upon remaining time of travel from those that rely on a straight-line or distance calculation. For example, keywords may be generated by geographic fence technology, known to artisans of ordinary skill, such that when LAD 110 crosses the fence, an alert is transmitted in accord with traveler alert system 100 as described above. On the other hand, the location of LAD 110, at the time of auction, may fall within a specified range based on either distance or remaining time of travel (RTT).

Unlike typical geographic boundary fences that are typically defined by a radius, in embodiments hereof, the preferred fence is calculated based upon RTT of LAD 110 to a merchant location (or other location as may be selected), which results in a variable distance but constant time of travel.

Specifically, map 2800, generated by map data server 144, shows the location of three separate LADs 110A, 110B, and 110C, each traveling along actual travel routes 2820, 2825 and 2845 over roadways 2805, 2815, and 2835, respectively. Each of the paths takes a corresponding LAD 110 within proximity to merchant location 2840.

Locations A1, A2 and A3 correspond to locations of LAD 110A moving along route 2820; locations B1, B2 and B3 correspond to locations of LAD 110B moving along route 2845; and locations C1, C2, and C3 correspond to locations of LAD 110C moving along route 2825. Table 2850 shows measured lineal distance and the remaining time for each location of LADs 110A, 110B, and 110C.

Table 2850 also shows example keywords selected by MBRS 160. Table 2860 tabulates the relevancy of each keyword based on the operation of each keyword, if any, and the same value applied to each, i.e., 5 miles or 5 minutes as shown in table 2850. The RTT range keyword captures the most LAD 110 locations while distance fence and RTT fence keywords are only applicable to locations crossing the fence, e.g., LAD 110B at location B1 and LAD 110C at Location C1.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between. In particular, the following embodiments are specifically contemplated, as well as any combinations of such embodiments that are compatible with one another:
A. A method sends merchant alerts to a traveler, including the steps of: receiving, within a traveler alert server from each of a plurality of merchants, at least one bid defining one or more keywords and a corresponding alert; receiving, within the traveler alert server from a location aware device (LAD), location data defining a current location of the traveler; ordering the corresponding alerts by performing a generalized second-price (GSP) auction based upon the location data, a merchant location of each of the plurality of merchants, and the at least one bid of each of the plurality of merchants; and sending the ordered corresponding alerts to the LAD for display to the traveler.
B. The method of embodiment A, the step of sending including starting a timer defining a period when the traveler may respond to the ordered corresponding alerts within a reverse auction.
C. The method of either embodiment A or B, further including receiving an indication of selection of one of the ordered corresponding alerts from the LAD; and redirecting the LAD to a website corresponding to the selection.
D. The method of any of the embodiments A through C, the step of performing the GSP auction including, for the at least one bid of each of the plurality of merchants, matching the keywords to the location data to determine whether the bid is entered into the auction.
E. The method of any of the embodiments A through D, further including the steps of: determining a remaining travel time (RTT) for the traveler to reach a merchant location corresponding to the at least one bid; and matching the keywords to the RTT.
F. The method of any of the embodiments A through E, further including the step of determining a bid value for the at least one bid based upon the match between the keywords and the RTT.
G. The method of claim 6, further including the steps of: receiving, within the traveler alert server from the LAD, traveler preferences that define current preferences of the traveler; and determining entry of the at least one bid for each of the plurality of merchants into the GSP auction based upon the corresponding RTT and one or more keywords defined within the traveler preferences.
H. The method of any of the embodiments A through G, the step of performing the GSP auction including matching the keywords to the location data and the traveler preferences to determine a bid value.
I. The method of any of the embodiments A through H, the step of performing the GSP auction including evaluating the business rules to determine a bid value for the at least one bid.
J. The method of any of the embodiments A through I, the business rules including a set of electronic directions provided by each of the plurality of merchants to automatically generate and modify the corresponding alert.
K. The method of any of the embodiments A through J, further including the steps of: sending the location data and the traveler preferences to a merchant advertiser business rule server of one of the plurality of merchants; and receiving, from the merchant advertiser business rule server, a dynamically generated bid for entry into the GSP auction.
L. The method of any of the embodiments A through K, further including the steps of: determining a route of the LAD; and selecting the at least one bid for each of the plurality of merchants for entry into the GPS auction based upon a merchant location corresponding to the at least one bid being proximate the route.
M. The method of any of the embodiments A through L, the step of determining the route including determining, based upon the location data, at least one hypothetical route for the LAD based upon a mode of transport of the traveler and map data.
N. The method of any of the embodiments A through M, the step of determining the route including receiving the route from the LAD.
O. The method of any of the embodiments A through N, further including the steps of: sending the route to a merchant advisor business rules server from the traveler alert server; and receiving, within the traveler alert server, the at least one bid from the merchant advisor business rules server, the at least one bid being based upon the route and the merchant location.
P. The method of any of the embodiments A through O, further including selecting the at least one bid for entry into the GSP auction based upon a geographic vicinity defined relative to a current location of the LAD determined from the location data.
Q. The method of any of the embodiments A through P, further including selecting the at least one bid for entry into the GSP auction based upon a geographic vicinity defined relative to a determined route of the LAD.
R. The method of any of the embodiments A through Q, further including selecting the at least one bid for entry into the GSP auction based upon a geographic vicinity defined relative to the merchant location corresponding to the at least one bid.
S. A traveler alert server sends merchant alerts to a traveler, and includes: at least one processor; a memory; a merchant locations system login (MLSL) for receiving, from each of a plurality of merchants, at least one keyword bid corresponding to a merchant location; an auction server for performing a generalized second-price (GSP) auction based upon location data defining a current location of the traveler received from a location aware device (LAD), the merchant location of each of the plurality of merchants, and the at least one keyword bid, to order a plurality of alerts corresponding to the at least one keyword bid; an alert generator for sending the ordered alerts to the LAD for display to the traveler; and a transaction module for receiving an input indicating selection of one of the ordered alerts by the traveler.
T. The traveler alert server of embodiment S, further including an ETA/RTT resolver, implemented within the memory, for determining one or both of an RTT and an ETA for the traveler to arrive at the one or more merchant locations based upon the location data.
U. A non-transitory computer readable medium with computer executable instructions stored thereon executed by a traveler alert processor performs the method of sending merchant alerts to a traveler, and includes: instructions for receiving, from each of the plurality of merchants, at least one bid based upon business rules defining keywords and a corresponding alert; instructions for receiving, within a traveler alert server from a location aware device (LAD), location data defining a current location of the traveler; instructions for performing a generalized second-price (GSP) auction based upon the location data, a merchant location corresponding to the at least one bid of each of the plurality of merchants, and a value of the at least one bid of each of the plurality of merchants to order the corresponding alerts based upon results of the auction; and instructions for performing a reverse auction by sending the ordered corresponding alerts to the LAD for display to the traveler and starting a timer for the reverse auction defining a period when the traveler may respond to the ordered corresponding alerts.

What is claimed is:

1. A method for sending merchant alerts to a traveler, comprising:
receiving, within a traveler alert server from each of a plurality of merchants, at least one bid defining one or more bid keywords and a corresponding alert;
receiving, within the traveler alert server, location data from a location aware device (LAD) defining a current location of the traveler;
determining, based upon the location data, a remaining travel time (RTT) for the traveler to reach a merchant location corresponding to the at least one bid;
ordering the corresponding alerts via a generalized second-price (GSP) auction based upon (a) the location data, (b) a merchant location of each of the plurality of merchants, and (c) the at least one bid of each of the plurality of merchants where the bid keywords match the corresponding RTT; and
transmitting the ordered corresponding alerts to the LAD for display to the traveler.

2. The method of claim 1, the step of transmitting comprising starting a timer defining a period when the traveler may respond to the ordered corresponding alerts within a reverse auction.

3. The method of claim 1, further comprising:
receiving an indication of selection of one of the ordered corresponding alerts from the LAD; and
redirecting the LAD to a web site corresponding to the selection.

4. The method of claim 1, the GSP auction comprising, for the at least one bid of each of the plurality of merchants, matching the bid keywords to the location data to determine whether the bid is entered into the auction.

5. The method of claim 1, further comprising determining a bid value for the at least one bid based upon the match between the bid keywords and the RTT.

6. The method of claim 1, further comprising:
receiving, within the traveler alert server from the LAD, traveler preferences that define current preferences of the traveler; and
determining entry of the at least one bid for each of the plurality of merchants into the GSP auction based upon the corresponding RTT and one or more traveler keywords defined within the traveler preferences.

7. The method of claim 6, the GSP auction comprising matching the bid keywords to the location data and the traveler preferences to determine a bid value.

8. The method of claim 7, the GSP auction comprising evaluating business rules to determine a bid value for the at least one bid.

9. The method of claim 8, the business rules comprising a set of electronic directions provided by each of the plurality of merchants to automatically generate and modify the corresponding alert.

10. The method of claim 6, further comprising:
sending the location data and the traveler preferences to a merchant advertiser business rule server of one of the plurality of merchants; and
receiving, from the merchant advertiser business rule server, a dynamically generated bid for entry into the GSP auction.

11. The method of claim 1, further comprising:
determining a route of the LAD; and
selecting the at least one bid for each of the plurality of merchants for entry into the GPS auction based upon a merchant location corresponding to the at least one bid being proximate the route.

12. The method of claim 11, the step of determining the route comprising determining, based upon the location data, at least one hypothetical route for the LAD based upon a mode of transport of the traveler and map data.

13. The method of claim 11, the step of determining the route comprising receiving the route from the LAD.

14. The method of claim 11, further comprising:
sending the route to a merchant advisor business rules server from the traveler alert server; and
receiving, within the traveler alert server, the at least one bid from the merchant advisor business rules server, the at least one bid being based upon the route and the merchant location.

15. The method of claim 1, further comprising selecting the at least one bid for entry into the GSP auction based upon a geographic vicinity defined relative to a current location of the LAD determined from the location data.

16. The method of claim 1, further comprising selecting the at least one bid for entry into the GSP auction based upon a geographic vicinity defined relative to a determined route of the LAD.

17. The method of claim 1, further comprising selecting the at least one bid for entry into the GSP auction based upon a geographic vicinity defined relative to the merchant location corresponding to the at least one bid.

18. A traveler alert server for sending merchant alerts to a traveler, comprising:
at least one processor;
a memory;
a merchant locations system login (MLSL) for receiving, from each of a plurality of merchants, at least one bid corresponding to a merchant location;
an ETA/RTT resolver, implemented within the memory, for determining one or both of an RTT and an ETA for the traveler to arrive at each of the one or more merchant locations based upon location data, defining a current location of the traveler, received from a location aware device (LAD) of the traveler;
an auction server for performing a generalized second-price (GSP) auction to order a plurality of alerts corresponding to the at least one bid based upon (a) the location data, (b) the merchant location of each of the plurality of merchants, and (c) the at least one bid of each of the plurality of merchants where the bid keywords match the corresponding RTT;
an alert generator for sending the ordered alerts to the LAD for display to the traveler; and
a transaction module for receiving an input indicating selection of one of the ordered alerts by the traveler.

19. A non-transitory computer readable medium with computer executable instructions stored thereon executed by a traveler alert processor to perform the method of sending merchant alerts to a traveler, comprising:
instructions for receiving, within a traveler alert server from each of a plurality of merchants, at least one bid defining one or more bid keywords and a corresponding alert;
instructions for receiving, within the traveler alert server from a location aware device (LAD), location data defining a current location of the traveler;
instructions for determining, based upon the location data, a remaining travel time (RTT) for the traveler to reach a merchant location corresponding to the at least one bid;
instructions for ordering the corresponding alerts by performing a generalized second-price (GSP) auction based upon (a) the location data, (b) a merchant location of each of the plurality of merchants, and (c) the at least one bid of each of the plurality of merchants where the bid keywords match the corresponding RTT; and
instructions for sending the ordered corresponding alerts to the LAD for display to the traveler.
